(19) United States
(12) Patent Application Publication
(10) Pub. No.: US 2022/0029398 A1
(43) Pub. Date: Jan. 27, 2022

(54) METHOD FOR THE APPLICATION OF A TUBULAR HULL TO AN ELECTRIC CABLE

(71) Applicant: Swiss Inventix GmbH, Lostorf (CH)

(72) Inventor: Stefan NEUHOLD, Lostorf (CH)

(73) Assignee: Swiss Inventix GmbH, Lostorf (CH)

(21) Appl. No.: 17/297,214

(22) PCT Filed: Dec. 12, 2019
(86) PCT No.: PCT/EP2019/083294

§ 371 Date: May 26, 2021

(30) Foreign Application Priority Data
Dec. 3, 2018 (EP) 18209728.7

(51) Int. Cl. H02G 3/04; H02G 1/14; H01B 13/004

(52) U.S. Cl. CPC H02G 3/0481; H01B 13/004; H02G 1/14

(57) ABSTRACT

A method for the application of a tubular hull (120) to an electric cable (100) is provided. The tubular hull (120) comprises a plurality of ring-shaped elements (102) and/or of tube-shaped elements (101). The method comprises at least the following steps: a.) pre-arranging a part of the tubular hull (120) by means of a tubular hull application unit (200); b.) inserting the electric cable (100) into the tubular hull application unit (200) and into the pre-arranged part of the tubular hull (120); c.) removing the electric cable (100) from the tubular hull application unit (200); and x.) repeating steps a.), b.) and c.) at least two times and in consecutive order. Furthermore, a tubular hull application unit adapted for carrying out such a method and a tether produced according to this method and comprising an electric cable and a tubular hull are provided.

### TECHNICAL FIELD

The present invention concerns a method for the application of a tubular hull to an electric cable as well as a tubular hull application unit adapted for carrying out such a method.

### PRIOR ART

In many applications, electric tethers are used which are not only suited for the transmission of electric power and/or data signals, but which are also adapted to resist axial and radial mechanical loads at least to a certain degree. Data signals can be all sorts of electrically transmittable signals, such as control signals, steering signals, sensor signals and so on.

A technical field in which electric tethers are used that have to absorb substantial axial and radial mechanical loads is for example the field of airborne wind power stations. Airborne wind power stations comprise one or more electric generators mounted on a flying object which usually has an airplane-like construction. The propeller equipped generators are driven by wind and by special flight manoeuvres, in order to produce electric energy. The electric energy is transferred to the ground by means of one or several tethers which connect the airborne wind power station to a ground based station. The tethers thus serve partially to control the flight movements of the airborne wind power station and to transmit electric energy from the generators to the ground. To bring the airborne wind power station from the ground station into an optimal position in the air for energy production or to retrieve it from a position in the air back to the ground station, the electric generators can be used as electric motors. In these start and retrieving phases of the operation, electric energy is thus fed from the ground station to the airborne wind power station by means of one or more tethers.

Another exemplary application is the oil drilling industry in which electric cables are often used to transmit electric energy and/or control data from the water surface to the ground of the sea or vice versa, in order to supply the subsea equipment with electric energy or with steering signals and/or to receive control and/or sensor signals from the subsea equipment. Another application represents e.g. the towing of aircrafts in which the tether between the aircrafts does not only serve for towing, but also for transmitting electric power and/or data.

Due to strong and often changing winds or due to sea currents and/or sea disturbances or due to various other reasons, the electric tether can be exposed to high mechanical tensile stress with varying amplitude. As a result, the electric tether can show a significant elongation of its original length under high load conditions. Electric tethers are also exposed to mechanical stress, when being wound up on a drum. Bending an electric tether to the peripheral outer surface of a drum causes compression to the parts of the electric tether facing the centre of the drum and tension to the parts facing radially outwardly. As a consequence, the mechanical stress caused by winding up the electric tether onto a drum can also lead to plastic deformation of the electric conductors being provided within the electric tether.

An axial tension of an electric tether and external mechanical stress does not only lead to an elongation of the tether along of its longitudinal direction, but can also lead to significant radial contraction of the electric tether at the same time. Such a radial contraction of the tether can particularly be caused by a helically braided outer layer of the tether that serves to absorb axial forces acting on the tether. Particularly sensible with respect to radial contractions are the electric conductors of the tether, but also possible insulation layers and/or semi-conductive layers or optical fibers that might be present within the electric tether. As a result, radial compression forces can occur which act on the inner parts of the tether and can easily lead to plastic deformation and overall failure of the electric tether. Thus, there is a need to protect the inner parts of the electric tether from radial compression.

One solution to protect an electric cable from radial compression is disclosed in the document WO 2016/062735 A1 of the applicant. In this document, it is proposed to apply a compression resistant layer to the outside of the electric cable. For the compression resistant layer, it is further proposed to use a plurality of ring-shaped compression resistant elements made of e.g. a ceramic, metallic or a fibre reinforced material. The efficient application of a tubular hull made of such ring-shaped compression resistant elements to an electric cable remains, however, a yet unsolved problem in the state-of-the-art.

### SUMMARY OF THE INVENTION

It is an object of the present invention to provide an efficient method for the application of a tubular hull comprising a plurality of ring-shaped elements and/or of tube-shaped elements to an electric cable.

This object is solved by the method as claimed in claim 1. Further embodiments of the method are provided in the dependent claims. A tubular hull application device adapted to apply a tubular hull to an electric cable according to such a method is provided in claim 15.

The present invention thus provides a method for the application of a tubular hull to an electric cable, the tubular hull comprising a plurality of ring-shaped elements and/or of tube-shaped elements, wherein the plurality of ring-shaped elements and/or of tube-shaped elements are arranged one behind the other along the longitudinal direction of the electric cable, and wherein the method comprises at least the following steps in consecutive order:
a.) pre-arranging a part of the tubular hull by means of a tubular hull application unit;
b.) applying the pre-arranged part of the tubular hull to the electric cable by means of inserting the electric cable into the tubular hull application unit and into the pre-arranged part of the tubular hull;
c.) removing the electric cable from the tubular hull application unit; and
x.) repeating steps a.), b.) and c.) at least two times and in consecutive order

By consecutively and repeatedly pre-arranging a part of the tubular hull, inserting the electric cable into this pre-arranged part of the tubular hull and removing the electric cable from the tubular hull application unit, a tubular hull comprising a plurality of ring-shaped elements and/or of tube-shaped elements can efficiently be applied to an electric cable.

The electric cable can be a part of a tether, particularly of a tether as indicated in the claims and the description, in particular as indicated in claim 1 and/or in FIG. 10 and the description associated to FIG. 10, of WO 2016/062735 A1, the content of which is incorporated herein by reference in its entirety. Thus, the electric cable with the applied tubular hull is preferably part of a tether that is adapted for connecting an airborne wind power station to the ground. The tether preferably comprises two helical layers with opposite winding directions and/or at least one helically braided outer layer, in order to absorb axial forces acting on the tether. In other embodiments, the tether comprising the electric cable and the tubular hull can be adapted for subsea applications in the oil industry or for towing an aircraft. A large variety of other applications is conceivable.

The electric cable can in particular be adapted to transmit electric power in the medium voltage range (1 kV to 52 kV) and/or in the high voltage range (52 kV to 300 kV) and/or with voltages of even more than 300 kV.

After the application of the tubular hull to the electric cable, further process steps in the production of e.g. a tether can follow. For example, further layers or hulls can be applied to the outside of the tubular hull, such as a tensile armour layer being specifically adapted for absorbing tensile forces acting on the electric cable. The further layers or hulls can particularly be applied by means of a continuous industrial standard process, e.g. by braiding and/or winding a fiber material onto the outside of the tubular hull.

The electric cable usually comprises one, two or more layers of electric conductors that might be separated from each other by means of respective insulating layers and/or semi-conductive layers. The electric cable can also comprise optical fibers. Advantageously, the electric cable has an elastic core around which the one or more layers of electric conductors are arranged.

Each part of the tubular hull preferably comprises a plurality of ring-shaped and/or tube-shaped elements that are, more preferably, arranged one behind the other along the longitudinal direction of the electric cable. Each of the ring-shaped and/or tube-shaped elements can itself represent a part of the tubular hull. Thus, along the radial direction, the tubular hull preferably comprises one single layer only.

The tubular hull and in particular the ring-shaped elements and/or of tube-shaped elements preferably serve to protect the electric cable from radial compression. Thus, the tubular hull and in particular the ring-shaped elements and/or of tube-shaped elements are preferably designed such that they absorb at least 70% of the radial forces acting on the combined unit of electric cable and tubular hull. More preferably, the tubular hull and in particular the ring-shaped elements and/or of tube-shaped elements are designed such they absorb at least 90%, even more preferably at least 95% and most preferably at least 99% of the radial forces acting on the combined unit of electric cable and tubular hull. The tubular hull and in particular the ring-shaped elements and/or of tube-shaped elements are advantageously designed to absorb radial pressures of at least 100 bar or even a multiple thereof.

The tubular hull preferably has an inner diameter and/or an outer diameter, which is constant along the entire longitudinal extension of the tubular hull. The inner diameter of the tubular hull is preferably defined by the inner diameters of the plurality of ring-shaped elements and/or of tube-shaped elements. The outer diameter of the tubular hull is preferably defined by the outer diameters of the plurality of ring-shaped elements and/or of tube-shaped elements.

Preferably, all of the plurality of ring-shaped elements and/or of tube-shaped elements have the same inner or the same outer diameter. More preferably, all of the plurality of ring-shaped elements and/or of tube-shaped elements have the same inner and the same outer diameter. Most preferably, all of the plurality of ring-shaped elements have the same shape and dimension and/or all of the tube-shaped elements have the same shape and dimension.

The plurality of ring-shaped elements and/or of tube-shaped elements are advantageously structurally stable. During the entire application of the tubular hull to the electric cable, the ring-shaped elements and/or the tube-shaped elements are preferably not deformed, but maintain their original shape and dimensions. Preferably, the ring-shaped elements and/or the tube-shaped elements are compression-resistant in the sense that their radial compressibility is lower, in particular by a multiple lower, than the radial compressibility of the layers of the electrical cable that are arranged radially inside of the tubular hull.

The ring-shaped elements and/or the tube-shaped elements are preferably made of a ceramic, a metallic or a plastic material or of a metal alloy. In case of a ceramic material, it can for example be silicon carbide (SiC). The material can be fibre reinforced, particularly if it is a plastic material. Advantageously, in order to be able to absorb large radial forces, the ring-shaped elements and/or the tube-shaped elements have a thickness measured along the radial direction of at least 1.5 mm, more advantageously of at least 2 mm.

In order to absorb high radial forces, the ring-shaped elements and/or the tube-shaped elements advantageously have a young's modulus of at least 40 kN/mm², more advantageously of at least 50 kN/mm² and most advantageously of at least 80 kN/mm².

Usually, all of the ring-shaped and/or tube-shaped elements extend completely around the electric cable after application of the tubular hull to the electric cable, i.e. each of the ring-shaped and/or tube-shaped elements is closed along the circumferential direction around the electric cable. Preferably, the entire tubular hull is formed exclusively of ring-shaped and/or tube-shaped elements that are all circumferentially closed. The ring-shaped elements and/or the tube-shaped elements are usually and advantageously already circumferentially closed before they are applied to the electric cable. In some embodiments, however, it is also possible that the ring-shaped and/or tube-shaped elements are not closed, but e.g. have a C-shaped form each.

In step a.), the ring-shaped and/or tube-shaped elements or the respective part of the tubular hull are particularly aligned, such that their openings are flush and the electric cable can easily be inserted into the openings of all ring-shaped and/or tube-shaped elements of the respective part of the tubular hull. In step b.), the pre-arranged and particularly such pre-aligned ring-shaped and/or tube-shaped elements of the respective part of the tubular hull are advantageously firmly held by the tubular hull application unit, in order to not be moved during the insertion of the electric cable.

In step c.), the electric cable is preferably removed such from the tubular hull application unit, that it is completely drawn out of the tubular hull application unit along of its longitudinal direction and, advantageously, by means of a spooling/unspooling operation. The removal of the electric cable from the tubular hull application device is preferably and usually carried out with at least a part of the tubular hull being applied to the electric cable.

The parts of the tubular hull that are applied to the electric cable in each repetition of step b.) in step x.) are preferably arranged one behind the other along the longitudinal direction of the electric cable, when the application of the tubular hull to the electric cable is completed. In other words, in each repetition of step b.) in step x.), the pre-arranged part of the tubular hull is preferably applied such to the electric cable, that the pre-arranged part of the tubular hull is placed, with respect to the longitudinal direction of the electric cable, next to a part of the tubular hull that has already been applied to the electric cable in a previous step b.). Thus, with each repetition of step b.), preferably a larger part of the longitudinal extension of the electric cable is covered by the tubular hull.

In step x.), steps a.), b.) and c.) are preferably repeated until the tubular hull covers most of the overall longitudinal extension of the electric cable, in particular until the tubular hull covers essentially the entire overall longitudinal extension of the electric cable. In doing so, a tubular hull can be obtained that protects the electric cable optimally against external influences and particularly against radial compression which might be caused e.g. by outer layers acting on the electric cable due to axial tension or by spooling the electric cable onto a drum.

In step b.) and before step x.), e.g. in the first carrying out of step b.), the pre-arranged part of the tubular hull is preferably applied approximately to the middle of the electric cable. The middle of the electric cable here refers to the center of the electric cable along of its entire longitudinal extension. Furthermore, in the first repetition of step b.) in step x.), preferably in each odd-numbered repetition of step b.) in step x.), the electric cable is advantageously inserted into the pre-arranged part of the tubular hull along a first longitudinal direction of the electric cable. In the second repetition of step b.) in step x.), preferably in each even-numbered repetition of step b.) in step x.), the electric cable is advantageously inserted into the pre-arranged part of the tubular hull along a second longitudinal direction of the electric cable, wherein the second longitudinal direction of the electric cubic extends oppositely to the first longitudinal direction of the electric cable. In other words, in a particularly preferred embodiment, a first part of the tubular hull is applied approximately to the middle of the electric cable, a second part is then applied directly adjacent to the first part, e.g. on the left-hand side of the first part, and a third part is then also applied directly adjacent to the first part, but on the different side than the second part, e.g. on the right-hand side of the first part. This procedure is preferably repeated by alternatingly applying further parts of the tubular hull directly adjacent to the already applied part of the tubular hull, e.g. by applying the further parts alternatingly on the left-hand side and on the right-hand of the already applied part of the tubular hull. It has been found out, that by applying this procedure, the total length of the electric cable that has to be moved through the tubular hull application unit can be reduced as compared to a procedure in which the first part of the tubular hull is applied to an end of the electric cable and the further parts are then applied consecutively one after the other along the entire longitudinal extension of the electric cable. In the latter case, the repeating insertion and removal of the electric cable into and out of the tubular hull application unit requires more total cable length to be moved through the tubular hull application unit.

In each repetition of step b.) in step x.), the pre-arranged part of the tubular hull is preferably applied such to the electric cable, that the pre-arranged pan of the tubular hull is placed directly adjacent to a part of the tubular hull that has already been applied to the electric cable in a previous step b.). Thus, each further part of the tubular hull is preferably applied such to the electric cable that there is no gap between the further part and the part of the tubular hull that has already been applied to the electric cable previously. The previously applied part of the tubular hull can of course be formed by a plurality of parts that have been applied to the electric cable in different repetitions of step b.). Advantageously, the further parts are applied such to the electric cable that there are no gaps between adjacent pans of the tubular hull during the entire process of the application of the tubular hull. In other embodiments, however, it is also possible that each further part is applied at a distance to the previously applied parts of the tubular hull and that the individual parts are then compacted. i.e. moved towards each other, at the end of each of step b.), at the end of the entire tubular hull application process or that they are not compacted at all.

Preferably, the outer diameter of the electric cable is larger than the inner diameter of the tubular hull in a state before the application of the tubular hull to the electric cable. In the state before the application of the tubular hull to the electric cable, both the electric cable and the tubular hull. i.e. in particular the ring-shaped elements and/or tube-shaped elements, are usually in a relaxed, i.e. uncompressed state in which the respective material is under no external pressure. As a consequence, for the insertion of the electric cable into the part of the tubular hull in step b.1, a certain force is required, in order to compress the electric cable and/or expand the part of the tubular hull and to overcome the resulting frictional forces. As an advantage, the tubular hull is firmly fixed after the completed insertion of the electric cable such that a movement of the ring-shaped elements and/or of tube-shaped elements relative to the electric cable is only possible by means of applying a substantial force that is preferably by a multiple higher than the gravitational force. Furthermore, the electric cable and/or the tubular hull can be pre-tensioned.

A considerable improvement of the efficiency in the application of the tubular hull to the electric cable can be achieved, if the tubular hull application unit comprises a plurality of tubular hull application subunits, and if each part of the tubular hull that is pre-arranged in step a.) and applied to the electric cable in step b.) comprises a plurality of subparts which are applied to the electric cable distantly from each other, and preferably simultaneously, by means of the tubular hull application subunits. Preferably, one or several intermediate conveying devices are used for conveying the electric cable between the tubular hull application subunits. In this way, the maximally applied pulling force to the electric cable can be reduced, in order to avoid a damage of the electric cable. Advantageously, the subparts are first applied distantly, but preferably simultaneously, from each other to the electric cable and are then moved towards each other in step b.), in order to be arranged directly adjacent to each other.

In a particularly preferred embodiment, the insertion of the electric cable into the pre-arranged part of the tubular hull in step b.) is carried out in a spooling/unspooling process by means of drums. The use of drums considerably facilitates the handling of the electric cable during the entire process.

In a further preferred embodiment, at least one pull-in rod is used, in order to attach the electric cable to one of the drums. By means of a pull-in rod, the electric cable can be connected to one of the drums and be pulled through the tubular hull application unit by simply spooling the pull-in rod onto the drum. Preferably, two pull-in rods are provided, in order to attach each end of the electric cable to a drum.

Furthermore, preferably at least one drum connection rope is used, in order to attach the pull-in rod to one of the drums. Due to the provision of the drum connection rope, the pull-in rod does not have to be directly connected to the drum, which simplifies the handling for example in situations in which the drum is located at a certain distance from the tubular hull application unit. Preferably, two drum connection ropes are provided, in order to connect a pull-in rod on each end of the electric cable to a drum.

In a certain embodiment of the invention, the drums are linearly moved during the spooling % unspooling process, in order to not deflect the electric cable in the region between the drums. In doing so, preferably each drum moves along of its spooling axis around which the drum rotates for spooling % unspooling the electric cable. By linearly moving the drums during the spooling/unspooling process, the electric cable can be guided such that it always extends perpendicularly from the spooling axis of each drum in the region between the drums and is not deflected in this region. In another embodiment of the invention, the same effect can be achieved by rotating each of the drums during the spooling/unspooling process about an axis perpendicular to the spooling axis, in order to not deflect the electric cable in the region between the drums.

The electric cable and/or the pull-in rod to which the electric cable is attached is preferably inserted into the part of the tubular hull by means of air pressure in step b.).

In a particularly preferred embodiment, in step a.), one or several of the ring-shaped elements and/or one or several of the tube-shaped elements are pre-arranged by means of at least one rotating wheel having one or several seats for receiving one of the ring-shaped elements and/or one of the tube-shaped elements. By using a rotating wheel, the process can be carried out in a particularly automated and efficient manner. During the insertion of the electric cable in step b.), the ring-shaped element and/or the tube-shaped element are advantageously held in place on the rotating wheel by means of underpressure. Preferably, a plurality of rotating wheels are provided for the pre-arrangement of ring-shaped elements and/or of tube-shaped elements in step a.). The plurality of rotating wheels is advantageously driven by a common drive.

The present invention also provides a tubular hull application device adapted to apply a tubular hull to an electric cable according to the method as indicated above. The tubular hull application device comprises at least one tubular hull application unit for pre-arranging a part of the tubular hull as well as drums for moving the electric cable in and out of the pre-arranged pan of the tubular hull. The tubular hull application unit preferably comprises one or more rotating wheels for pre-arranging the part of the tubular hull. The one or more rotating wheels advantageously comprise means, in particular a vacuum unit, for firmly holding the pan of the tubular hull during the insertion of the electric cable. As an alternative to a vacuum unit, a mechanical clamping unit could also be provided for the same purpose.

Thus, the present invention is directed to both a method and a device for producing a tether comprising an electric cable to which a tubular hull is applied in such a way that the tubular hull covers essentially the entire overall longitudinal extension of the electric cable, wherein the tubular hull preferably comprises a plurality of ring-shaped elements made from a relatively flexible first material and of tube-shaped elements made from a relatively inflexible second material that are arranged in alternating order along the longitudinal extension of the electric cable. A tether having such a design has a good flexibility and the electric cable of the tether is still optimally protected from radial forces.

The extension of the tube-shaped elements along the longitudinal direction of the electric cable is preferably, but not necessarily, larger than the extension of the ring-shaped elements along the same direction. The ratio of the longitudinal length of each of the ring-shaped and tube-shaped elements relative to the entire longitudinal extension of the electric cable is preferably at least 1:1000, more preferably at least 1:5000, most preferably at least 1:10′000. The same ratio preferably also applies concerning the longitudinal length of each ring-shaped and tube-shaped element with respect to the entire longitudinal extension of the tubular hull. An electric cable having a tubular hull with such a design is particularly well protected from external radial forces, but still has certain flexibility.

In order to achieve good bending properties of the tether, the length of each of the ring-shaped and tube-shaped elements is preferably less than 20 times the diameter of the electric cable. For enabling a winding up of the tether on a drum without damages, the diameter of the drum should advantageously be at least 20 times larger than the outer diameter of the ring-shaped and/or tube-shaped elements.

In an alternative application, the electric cable can also be part of a tether that is used to mechanically hold a submersible power plant. Respective submersible power plants are for example known from WO 2015/119543 A1 and WO 2014/193281 A1.

### SHORT DESCRIPTION OF THE FIGURES

Preferred embodiments of the invention are described in the following with reference to the drawings, which only serve for illustration purposes, but have no limiting effects. In the drawings it is schematically shown:

FIG. 1 a central longitudinal section of a tubular hull application device adapted to carry out the inventive method,

FIG. 2a) a cross section of a tether with an inner electric cable surrounded by a tubular hull and a further outer layer; b) a central longitudinal section of the electric cable and the tubular hull of the tether of FIG. 2a); c) a central longitudinal section of the electric conductor unit of the electric cable of FIG. 2a); d1) a more detailed cross section of the electric cable and the tubular hull of the tether of FIG. 2a, according to a first variant; d2) a more detailed cross section of the electric cable and the tubular hull of the tether of FIG. 2a, according to a second variant; d3) a more detailed cross section of the electric cable and the tubular hull of the tether of FIG. 2a, according to a third variant;

FIG. 3a) a longitudinal section of a tubular hull application device having linearly moveable drum units adapted to carry out the inventive method, in a first position; b) the tubular hull application device of FIG. 3a), in a second position; c) the tubular hull application device of FIG. 3a), in a third position; d) a visualization of the area required by the tubular hull application device of FIG. 3a) during the spooling/unspooling process;

FIG. 4a) a longitudinal section of a tubular hull application device having rotary drum units adapted to carry out the inventive method, in a first position; b) the tubular hull application device of FIG. 4a), in a second position; c) the tubular hull application device of FIG. 4a), in a third position; d) a visualization of the area required by the tubular hull application device of FIG. 4a) during the spooling/unspooling process;

FIG. 5 a central longitudinal section of one of the linearly moveable drum units of the tubular hull application device of FIG. 3;

FIG. 6 a cross section/side view of one of the rotary drum units of the tubular hull application device of FIG. 4;

FIG. 7a) a cross section of a tube and ring feeder unit of the tubular hull application device of FIG. 1; b) a longitudinal section of the tube and ring feeder unit of FIG. 7a) through line A-A; c) a top view of two tube and ring feeder units as shown in FIG. 7a arranged directly adjacent to each other;

FIG. 8a) a top view of three tube and ring feeder units as shown in FIG. 7a) arranged directly adjacent to each other and having common elements to form a tubular hull application unit or at least a part thereof; b) a cross section of the tubular hull application unit of FIG. 8a), in an open position:

FIG. 9a) a cross section of a tube feeder wheel of the tube and ring feeder unit of FIG. 7a), with stiff tubes being held in seats of the tube feeder wheel; b) a cross section of the pressure control unit of the tube feeder unit of the tube and ring feeder unit of FIG. 7a); c) a cross section of the pressure control unit of the ring feeder unit of the tube and ring feeder unit of FIG. 7a); d) a longitudinal section of a part of the tube and ring feeder unit of FIG. 7a), with the tube feeder wheel of FIG. 9a), through line A-A; c) a view onto a part of the periphery of the tube feeder wheel of FIG. 9a); f) a view onto a part of the periphery of the ring feeder wheel of the tube and ring feeder unit of FIG. 7a);

FIG. 10a) a cross section of a tubular hull application unit of the tubular hull application device of FIG. 4 with rotary drum units, according to a first variant; b) a cross section of a pan of a tubular hull application unit of the tubular hull application device of FIG. 4, with rotary drum units, according to a second variant; c) a cross section of one of the rolling ball bearings of the tubular hull application unit of FIG. 10a); d) a cross section of one of the moveable base plate and the gliding plate of the tubular hull application unit of FIG. 10b); e) a top view of the tubular hull application unit of FIG. 10a):

FIG. 11 top part of each subfigure; central longitudinal views through the hull application unit as well as through parts of the drums and the electric cable for illustrating the first part of the tubular hull application process; bottom part of each subfigure; the electric cable along of its entire length, with the tubular hull applied thereon according to the illustrated state of the tubular hull application process; a) the tubular hull application device in its starting position; b) with the first pull-in rod extending through the tubular hull application unit; c) during the pulling of the electric cable through the tubular hull application unit; d) with the middle part of the electric cable being arranged in the closed tubular hull application unit; e) with the middle part of the electric cable being arranged in the opened tubular hull application unit:

FIG. 12 illustration of the second part of the tubular hull application process, with views in analogy to the ones of FIG. 11; a) start of the spooling of the electric cable to the right-hand drum as shown in the figure; b) with the second pull-in rod extending through the tubular hull application unit; c) after the second pull-in rod has been disconnected from the electric cable; d) after the second pull-in rod has been pulled out of the tubular hull application unit; e) with a further pan of the tubular hull being ready in the closed tubular hull application unit:

FIG. 13 illustration of the third part of the tubular hull application process, with views in analogy to the ones of FIG. 11; a) with the second pull-in rod being connected to the electric cable and extending through the tubular hull application unit; b) during the pulling of the electric cable through the tubular hull application unit; c) with the middle pan of the electric cable being arranged in the closed tubular hull application unit; d) with the middle part of the electric cable being arranged in the opened tubular hull application unit; e) start of the spooling of the electric cable to the left-hand drum as shown in the figure;

FIG. 14 illustration of the fourth part of the tubular hull application process, with views in analogy to the ones of FIG. 11; a) with the first pull-in rod extending through the tubular hull application unit; b) after the first pull-in rod has been disconnected from the electric cable; c) after the first pull-in rod has been pulled out of the tubular hull application unit; d) with another further part of the tubular hull being ready in the closed tubular hull application unit; c) with the first pull-in rod being connected to the electric cable and extending through the tubular hull application unit;

FIG. 15 illustration of the fifth part of the tubular hull application process, with views in analogy to the ones of FIG. 11; a) during the pulling of the electric cable through the tubular hull application unit; b) with the middle part of the electric cable being arranged in the closed tubular hull application unit; z) the final state of the tubular hull application process, in which the tubular hull covers the electric cable along of its substantially entire overall longitudinal extension;

FIG. 16a) a longitudinal section of the tubular hull application unit, a part of a drum and of the electric cable as well as of a compressed air insertion unit as a first variant for facilitating the insertion of the pull-in rods into the tubular hull application unit; b) a longitudinal section of the tubular hull application unit, a part of a drum and of the electric cable as well as of a linear conveying device as a second variant for facilitating the insertion of the pull-in rods into the tubular hull application unit; c) a longitudinal section of an end part of the electric cable with a pulling head protection layer;

FIG. 17 illustration of a compaction process for the tubular hull showing longitudinal sections of the electric cable with a part of the tubular hull applied thereto, in different states of the compaction process; a) the part of the tubular hull within the closed tubular hull application unit is not yet compacted; b) one of the tube and ring feeder units is opened; c) the electric cable is pulled to the left side of the figure; d) one of the tube and ring feeder units is opened; e) the electric cable is pulled to the left side of the figure;

FIG. 18 illustration of a possibility to speed-up the tubular hull application process by means of using a larger number of tubular hull application units; a) a tubular hull application device with a single tubular hull application unit and with the same configuration and in the same state as in FIG. 11b); b) a tubular hull application device with a plurality of tubular hull application devices and with intermediate conveying devices, in an analogue state as in FIG. 18a); c) a tubular hull application device with a single tubular hull application unit and with the same configuration and in the same state as in FIG. 11d); d) a tubular hull application device with a plurality of tubular hull application units and with intermediate conveying devices, in an analogue state as in FIG. 18c);

FIG. 19 illustration of the tubular hull application process using a plurality of tubular hull application units and with intermediate conveying devices; a) parts of the tubular hull have been applied to the electric cable and two of the tubular hull application units are in closed and one is in opened state; b) the electric cable has been pulled to the right-hand side of the figure; c) the middle tubular hull application unit is opened; d) the electric cable is pulled further to the right-hand side of the figure; x) the third tubular hull application unit is also opened; y) a tubular hull application device with a single tubular hull application unit in an analogous state as shown in FIG. 19x); and

FIG. 20 illustration of possible embodiments of an intermediate conveying device; a) a side view/longitudinal section of a first variant of an intermediate conveying device; b) detailed cross section through one of the drive wheels of the intermediate conveying device of FIG. 20a); c) a perspective view of a second variant of an intermediate conveying device; d) a detailed cross section through the peripheral part of one of the sheaves of the intermediate conveying device of FIG. 20c).

### DESCRIPTION OF PREFERRED EMBODIMENTS

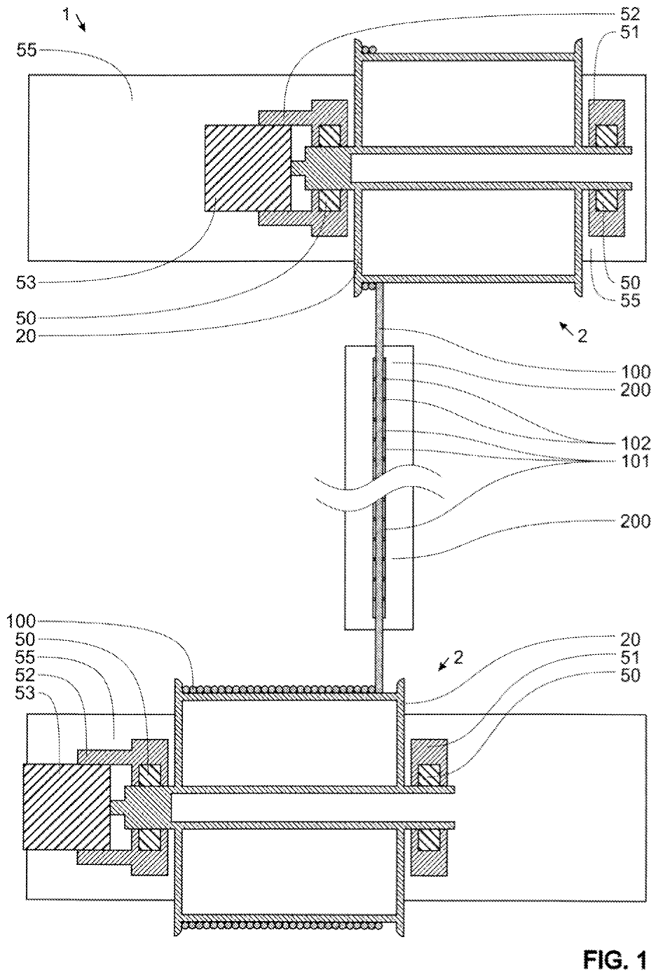

FIG. 1—Overview of the Tubular Hull Application Device

FIG. 1 shows a schematic overview of a tubular hull application device 1 for the application of stiff tubes 101 and flexible rings 102 to an electric cable 100.

The electric cable 100 is spooled from a first linearly moveable drum unit 2 to a second linearly moveable drum unit 2 by passing a tubular hull application unit 200. At the tubular hull application unit 200, stiff tubes 101 and flexible rings 102 are supplied for the application to the electric cable 100. Each of the linearly moveable drum units 2 contains a drum 20 for spooling and unspooling the electric cable 100. Each of the drums 20 is driven by a linearly moveable drum unit drive 53. The linearly moveable drum unit drives 53 are held by a linearly moveable drum unit bearing and drive block 52 in each case. The drums 20 run on two linearly moveable drum unit bearings 50 which are fixed in a linearly moveable drum unit bearing block 51 and in the linearly moveable drum unit bearing and drive block 52, respectively. In each case, the drum 20, together with its associated linearly moveable drum unit bearing block 51, the linearly moveable drum unit bearing and drive block 52 and the linearly moveable drum unit drive 53, is arranged, in a linearly movable manner, on a stationary drum unit base 55. During the spooling and unspooling operations, the drums 20 are linearly moved in opposite directions along their longitudinal center axes in such a way that the tubular hull application unit 200 can stay at a fixed place without deflecting the electric cable 100 between the drums 20.

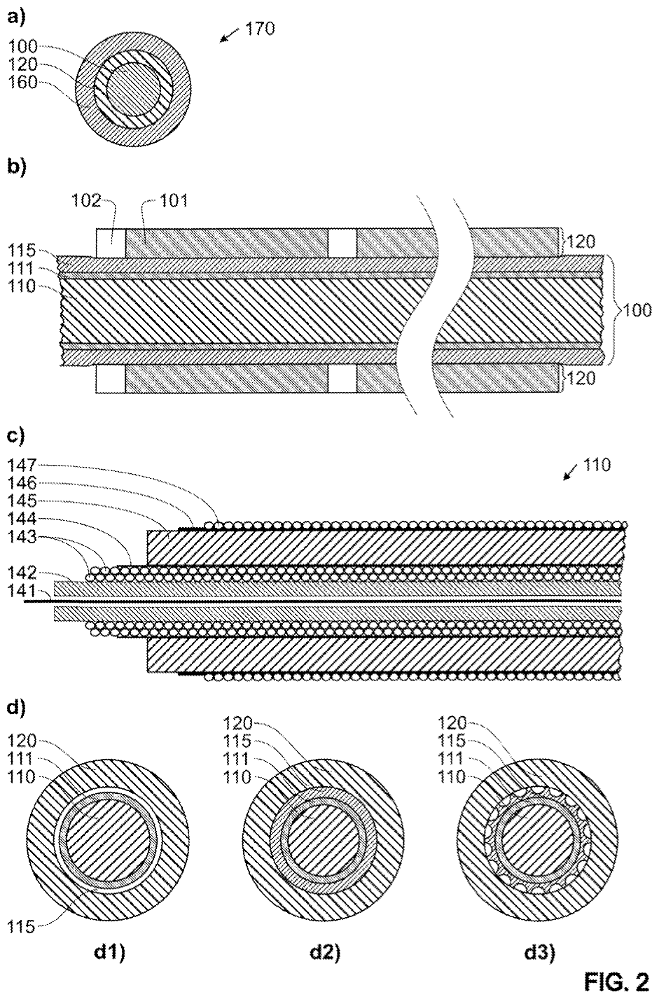

FIG. 2—Electric Cable with Tubular Hull

FIG. 2 shows different embodiments and stages in the production process of a tether 170 having the capability of transferring both high axial mechanical loads and electric power. The tether 170 is in particular adapted to transmit electric power in the medium voltage range (1 kV to 52 kV) and/or in the high voltage range (52 kV to 300 kV) and/or with voltages of even more than 300 kV. The tether 170 can particularly be designed according to the tether as indicated in the claims and the description, in particular as indicated in claim 1, of WO 2016/062735 A1.

FIG. 2a) shows a tether 170 comprising an electric cable 100, surrounded by a tubular hull 120. The tubular hull 120 is surrounded by a tensile armour layer 160. The tubular hull 120 protects the electric cable 100 against high contractional radial forces caused by the tensile armour layer 160, when the tether 170 is under tensile load. The tensile armour layer 160 can be made for example of synthetic high strength fibers like Kevlar, or Dyneema*.

The application of the tensile armour layer 160 on the outside of the tubular hull 120 is done using methods known well to the person skilled in the art, such as by spinning or braiding high strength fibers onto the outside the tubular hull 120 in a continuous industrial standard process.

The application of the tubular hull 120 to an electric cable like the electric cable 100 represents the subject of the present invention.

FIG. 2b) shows the electric cable 100 surrounded by a tubular hull 120 comprising stiff tubes 101 and flexible rings 102. The electric cable 100 comprises an electric conductor unit 110 surrounded by a protection layer 111 and a buffer layer 115 which surrounds the protection layer 111.

The stiff tubes 101 made of a high strength material protect the electric cable 100 against high contractional forces caused by e.g. the tensile armour layer 160 and high asymmetric radial forces caused by e.g. spooling operations under axial load of the tether 170. The flexible rings 102 provide a buffering between the stiff tubes 101 in order not to cause friction and wear and provide furthermore flexibility of the tether 170 which needs to be spoolable on a drum 20.

FIG. 2c) shows a possible embodiment of the electric conductor unit 110, comprising a fiber optic cable/cables 141 in the center, surrounded by an elastic core 142, which is surrounded by one or more layers of axially helically arranged electric conductors 143, which are surrounded by a first semi-conductive layer 144, which is surrounded by an electric insulation 145, which is surrounded by a second semi-conductive layer 146, which also serve for buffering purposes and which is surrounded by one or more layers of electric conductors 147.

FIG. 2d) shows cross sections of different types of electric cables 100 having at least an electric conductor unit 110 and a protection layer 111 and being integrated into a tubular hull 120 comprising stiff tubes 101 and flexible rings 102.

The protection layer 111 serves to protect the electric system, i.e. the metallic wires of the electric conductors 147 and 143 as well as the electric insulation 145 and the semi-conductive layers 144 and 146, from humidity, compression, friction and/or wear. The protection layer 111 can also be provided in the form of simply a void space between the adjacent layers or may not be present at all.

As shown in the embodiment illustrated in subfigure d1), the buffer layer 115 can be present in the form of an annular gap between the protection layer 111 and the tubular hull 120 or even not be present at all. In the latter case, the protection layer 111 can be adapted to provide high static friction, in order to prevent a relative slip between the protection layer 111 and the tubular hull 120. If the buffer layer 115 is provided in the form of an annular gap as in the embodiment of subfigure d1), the protection layer 111 is loose with respect to the tubular hull 120, when the tether 170 is in its unloaded condition. The provision of such an annular gap can for example be advantageous for the application of the tubular hull 120 to the electric cable 100 during the production of the tether 170, particularly if the protection layer 111 is incompressible.

In the embodiment as shown in subfigure d2), a single buffer layer 115 is provided between the protection layer 111 and the tubular hull 120. The buffer layer 115 which fills out the space between the protection layer 111 and the tubular hull 120 can be made of a foam-based elastomer or a thermoplastic material having high elasticity. The buffer layer 115 can be radially pre-squeezed, in order to also fill out the space between the protection layer 111 and the tubular hull 120, when the tether 170 is under axial tension and, as a consequence, the electric cable 100 is radially contracted. Additionally or alternatively, the buffer layer 115 can be adapted to provide high static friction, in order to prevent a relative slip between the protection layer 111 and the tubular hull 120 in particular at the upper end of the tether 170 when the tether 170 spans from an elevated position to a lower position. In this way, a local axial stress to the electric system can be prevented.

The high static friction as mentioned above can be temporarily significantly reduced by a gliding agent, in order to facilitate an easy application of the tubular hull 120 with low friction. The reduction of the static friction by the gliding agent can be made undone by e.g. evaporation of the gliding agent or by a thermal treatment of the electric cable 100 after the tubular hull 120 has been applied. Since the effect of the dynamic friction is more pronounced than the one of the static friction, also standard solid gliding agents, such as graphite lubricant, polytetrafluorethylene or molybdenum-disulphide can be applied which do not dissipate. Also gliding agents are conceivable which first serve as lubricant during the tubular hull application process and later on can be modified to a glue-like or friction-enhancing material by means or a suitable process, such as thermal radiation, x-ray irradiation or ultrasound treatment.

In the embodiment as shown in subfigure d3) a single buffer layer 115 is provided which comprises a grip surface. The grip surface which is directed radially outwards towards the tubular hull 120 is realized by means of axial ribs extending along the entire longitudinal direction of the tether 170. Due to its grip surface, the buffer layer 115 centers the electric system 141-147 and the protection layer 111 in an elastic way within the tubular hull 120. In order to compensate for the reduction in diameter of the electric system when being axially stretched, the buffer layer 115 can be radially pre-tensioned correspondingly. Due to the void spaces being provided in the circumferential direction between the ribs of the grip surface, the elastic material of the buffer layer 115 is allowed to expand and contract. e.g., to compensate the thermal expansion of the electric conductor unit 110 under electric load. Here, the void spaces between the ribs have the shape of a semi-circle in cross section view, but of course other shapes of these void spaces are also conceivable.

The buffer layer 115 can for example be made of an elastomer, a silicone-elastomer or of a rubber material with high elasticity and thermal conductivity. In certain embodiments, the buffer layer 115 can be electrically conductive or semi-conductive.

During operation, the electric cable 100 produces thermal losses due to the electric resistance of the electric conductors 143, 147. The maximal allowable temperature of the electric insulation 145 to prevent failure of the electric system limits the allowable thermal losses per length unit of the electric cable 100. This limitation of the thermal losses per length unit for a given electric cable design is limiting the maximal power transfer capability of the electric cable 100. The thermal limit is dependent on the heat transfer capability of the surrounding layers of the electric cable 100 and the possible thermal dissipation to the environment. In order to achieve an optimal heat transfer capability between the electric cable 100 and the tubular hull 120, the protection layer 111 and the buffer layer 115 should feature a high heat transfer capability in the radial direction. If the electric cable 100 is loose within the tubular hull 120, the small annular air gap represents a significant reduction of the heat transfer capability in the radial direction. Therefore, a tight and preferably circumferential contact between buffer layer 115 and tubular hull 120 is advantageous for achieving a good power transfer capability of the electric cable 100. Of course, such a tight and preferably circumferential contact should also be present for all other layers, in order to prevent reduction of the heat transfer capability.

This tight and preferably circumferential contact between the buffer layer 115 and the tubular hull 120 under all operation conditions, especially under all thermal and tensile operation conditions, requires a certain radial pretension of the electric cable 100 which is preferably effected by means of stiff tubes 101 and flexible rings 102 having a slightly smaller inner diameter as compared to the outer diameter of the buffer layer 115 in the state before the application of the tubular hull 120.

In order to be able to apply the tubular hull 120 to the electric cable 100, the material of the buffer layer 115 preferably features a certain compressibility for the required reduction of the outer diameter to the inner diameter of the tubular hull 120. This compressibility can be achieved for example by using a foam-based elastomer or a thermoplastic material having high elasticity. The amount of air in the foam-based material has to be optimized with respect to the thermal heat transfer capability of the buffer layer 115.

If the buffer layer 115 features a surface with axial ribs as shown in FIG. 2, subfigure d3), the adaption of the outer diameter of the buffer layer 115 to the inner diameter of the tubular hull 120 can is achieved by the deformation of the axial ribs expanding into the void spaces between the axial ribs.

As a result of the above described diameter adaption between the buffer layer 115 and the tubular hull 120 during production of the tether 170, a certain tensile force has to be applied to the electric cable 100, when applying the tubular hull 120 and drawing the electric cable 100 therethrough. This tensile force is dependent on the required radial deformation and the friction between the buffer layer 115 and the tubular hull 120 which again is dependent on the length of the tubular hull 120 being applied. As a result and due to tensile limits of the electric cable 100, there is a certain limitation to the length of the part of the tubular hull 120 which can be applied to the electric cable 100 in one step.

The tensile limits of the electric cable 100 may be based on the maximal allowed geometrical changes of the cable construction in order to fulfil the fatigue life requirements for repetitive tensile stress.

As a conclusion, the application process of the tubular hull 120 to the electric cable 100 has to be carried out in consideration of the maximal allowed tensile force for the electric cable 100. For the application of the tubular hull 120, the electric cable 100 is preferably subdivided along of its longitudinal extension into a plurality of sections having the same limited lengths. Parts of the tubular hull 120 are then applied to one section after the other, i.e. in a stepwise manner, in order not to damage the electric system.

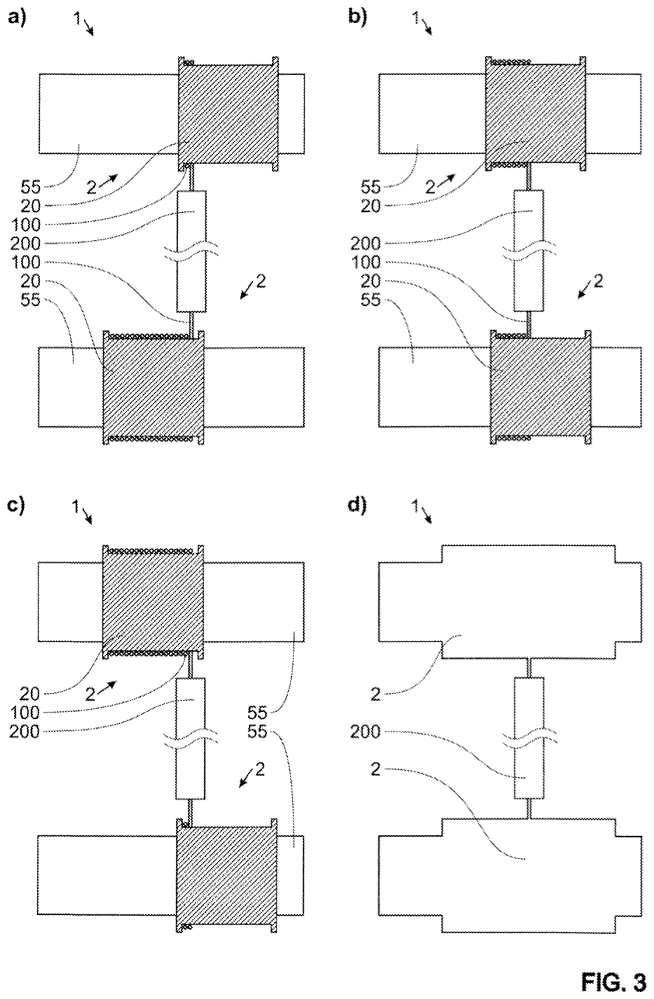

FIG. 3—Tubular Hull Application Device with Linearly Moveable Drum Units

FIG. 3 shows different stages of a tubular hull application process in which the electric cable 100 is spooled from a first linearly moveable drum unit 2 onto a second linearly moveable drum unit 2 by passing through the tubular hull application unit 200. The tubular hull application unit 200 is in a fixed position during the entire process. By linearly moving the drums 20 in opposite directions along of their longitudinal center axes during the spooling/unspooling process, a deflection of the electric cable 100 in the region between the two drums 20 and, as a result, a possible damage of the electric cable 100, can be prevented.

FIG. 3a) shows an early stage of the tubular hull application process in which the electric cable 100 is spooled from the linearly moveable drum unit 2 shown in the lower part of the figure to the linearly moveable drum unit 2 in the upper part of the figure.

FIG. 3b) shows an intermediate stage, and FIG. 3c) shows a late stage of the spooling/unspooling process.

FIG. 3d) visualizes the area required by the tubular hull application device 1 during the entire tubular hull application process.

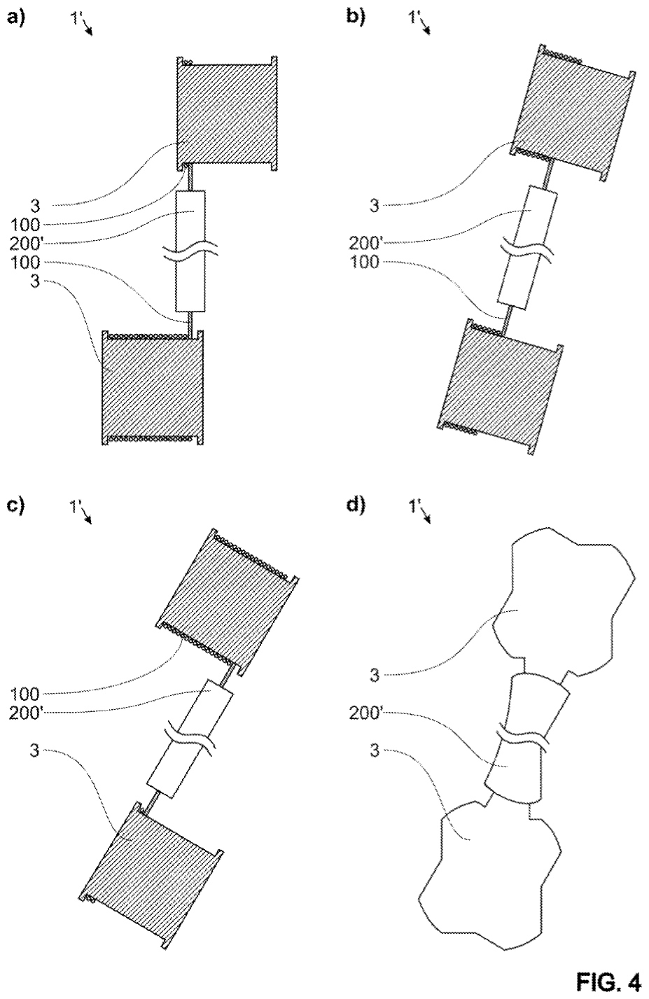

FIG. 4—Tubular Hull Application Device with Rotary Drum Units

FIG. 4 shows the tubular hull application process carried out on a tubular hull application device 1′ having a different design as compared to the tubular hull application device 1 shown in FIG. 3. Different stages of the tubular hull application process are shown, in which the electric cable 100 is spooled from a first rotary drum unit 3 to a second rotary drum unit 3 by passing through a tubular hull application unit 200′. As shown in FIG. 4, the tubular hull application unit 200′ is not fixed in position, but moveable. By rotating each of the rotary drum units 3 and the tubular hull application unit 200′ during the spooling/unspooling process, the electric cable 100 is not deflected in the region between the two rotary drum units 3, but always extends perpendicularly with respect to the longitudinal center axis of each rotary drum unit 3. In this way, a too strong bending and, as a result, damage of the electric cable 100 can be avoided.

FIG. 4a) shows an early stage of the tubular hull application process in which the electric cable 100 is spooled from the rotary drum unit 3 shown in the lower part of the figure to the rotary drum unit 3 shown in the upper part of the figure.

FIG. 4b) shows an intermediate stage, and FIG. 4c) shows a late stage of the spooling/unspooling process.

FIG. 4d) visualizes the area required by the tubular hull application device 1′ during the entire tubular hull application process. Compared with the tubular hull application device 1 having linearly moveable drum units 2 as shown in FIG. 3, the solution of the tubular hull application device 1′ having rotary drum units 3 shows advantages as concerns space requirements.

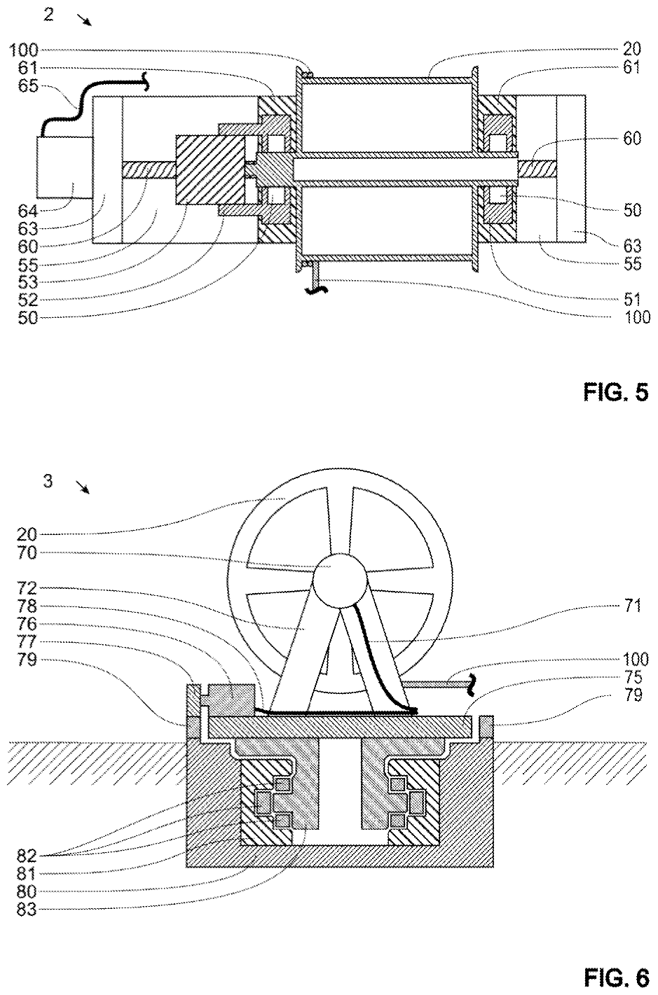

FIG. 5—Details of a Linearly Moveable Drum Unit

FIG. 5 shows a possible embodiment of the linearly moveable drum unit 2, the main elements of which have already been described further above with respect to FIG. 1. Various elements are attached to the stationary drum unit base 55 as shown in FIG. 5 that enable a controlled linear movement of the drum 20 in the direction of its longitudinal center axis. The drum 20 is attached to slides 61 via the linearly moveable drum unit bearing block 51 and the linearly moveable drum unit bearing and drive block 52, respectively. Each of the slides 61 has a threaded through-hole. The slides 61 can be connected with each other, in order to improve their structural stability. A threaded rod 60 extends along the longitudinal center axis of the drum 20 and through the threaded through-hole of each of the slides 61. On each side of the drum 20, a mounting block 63 is fixedly attached to the stationary drum unit base 35. The mounting blocks 63 serve to hold the threaded rod 60 in such a way that the threaded rod 60 is freely rotatable with respect to the mounting blocks 63. By means of rotating the threaded rod 60, the slides 61 and, thus, the drum 20 can be moved along the longitudinal center axis of the drum 20 owing to the engagement of the threaded rod 60 with the threaded through-holes of the slides 61. The linear movability of the drum 20 is limited in each direction by the mounting blocks 63. Slideways can be provided between the stationary drum unit base 55 and the slides 61, in order to precisely guide the slides 61 and, thus, the drum 20, along the desired linear direction. The rotation of the threaded rod 60 is effected by a drive 64. The drive 64 is supplied with electric power and controlled by control signals, which are both transmitted by a power and data cable 65.

FIG. 6—Details of a Rotary Drum Unit

FIG. 6 Shows a Possible Embodiment of the Rotary Drum Unit 3, the Main Functionality of which has been described further above with respect to FIG. 4. The rotary drum unit 3 as shown in FIG. 6 comprises various elements which enable a controlled rotational movement of the drum 20 around a vertical axis. The spooling and unspooling process of the drum 20 is driven by a drive 70 which is supplied with electric power and controlled by control signals that are both transmitted by a power and data cable 71. The drum 20 is held by a support 72 which is mounted on a rotary table 75. The rotary table 75 can be rotated around the vertical axis by means of a rotary table drive 76 which is supplied with electric power and controlled by control signals that are both transmitted by a further power and data cable 78. The rotary table drive 76 is fixedly mounted on the rotary table 75. The transfer of the torque effected by the rotary table drive 76 to the rotary table 75 is achieved by means of a toothed engagement of a drive gear 77 of the rotary table drive 76 with a toothed ring 79 that is coaxially arranged around the rotary table 75. The toothed ring 79 is fixed on a stationary base structure 80. Attached to the base structure 80 is also a bearing outer ring 81 with radial and axial cylinder bearings 82. The cylinder bearings 82 serve to hold an inner vertical cylindrical part 83 which is attached to the underside of the rotary table 75. The cylindrical part 83 is held such by the cylinder bearings 82 that the cylindrical part 83 and, thus, the rotary table 75 and the drum 20 are rotatable around the vertical axis.

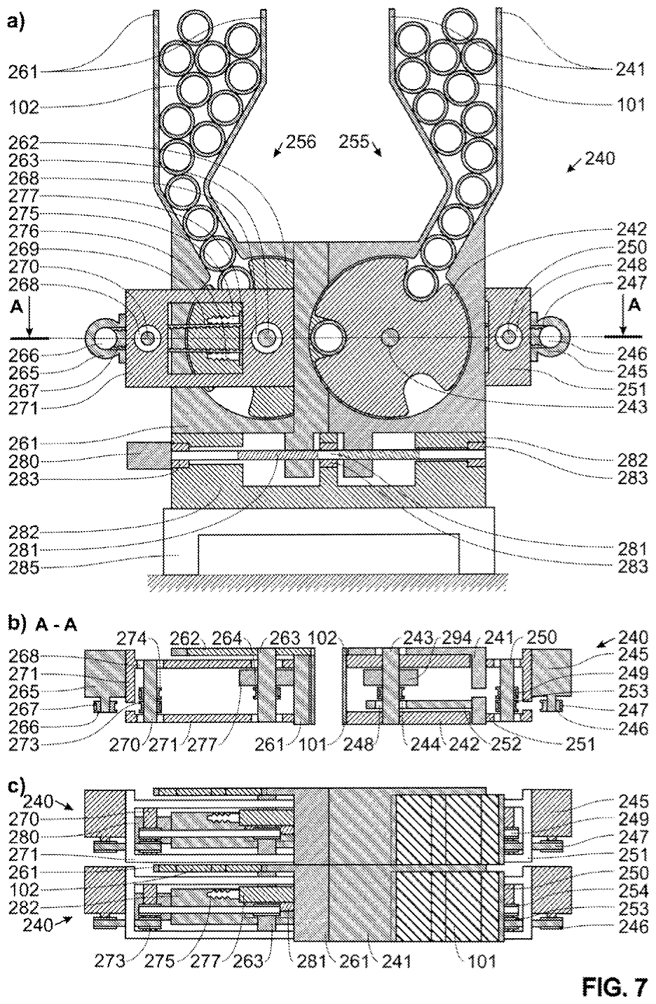

FIG. 7—Details of a tubular hull application unit

FIG. 7 shows a possible embodiment of a tube and ring feeder unit 240 which represents a part of the tubular hull application unit 200.

The purpose of the tube and ring feeder unit 240 is the controlled and automatized arrangement of a part of the tubular hull 120 comprising stiff tubes 101 and flexible rings 102 which are applied to the electric cable 100 in alternating order. The tube and ring feeder unit 240 as shown in FIGS. 7a, b) serves to coaxially arrange a single stiff tube 101 and a single flexible ring 102 in such a way that the electric cable 100 can be drawn through the stiff tube 101 and the flexible ring 102. By arranging a plurality of such tube and ring feeder units 240 directly next to each other, a simultaneous application of a plurality of stiff tubes 101 and flexible rings 102 to the electric cable 100 becomes possible in an alternating order. A top view of an exemplary arrangement of two such tube and ring feeder units 240 directly next to each other is shown in FIG. 7c). As explained further above with respect to FIG. 2, due to tensile force limitations of the electric cable 100, the application of the tubular hull 120 to the electric cable 100 needs to be carried out in a stepwise manner. Thus, there is a maximal number of stiff tubes 101 and flexible rings 102 that can be applied simultaneously to a respective section of the electric cable 100.

The tube and ring feeder unit 240 comprises a tube feeder unit 255 and a ring feeder unit 256 which are mounted on an opening drive frame 282 such as to be linearly movable towards each other.

The tube feeder unit 255 comprises a tube feeder frame 241 for the storage, supply and guidance of the stiff tubes 101 to be applied to the electric cable 100. The stiff tubes 101 are guided by a funnel formed by the tube feeder frame 241 to a tube feeder wheel 242 which has specific tube seats for the stiff tubes 101. The tube seats are provided in the form of rounded cut-outs that are radially open towards the outside and are provided at regular distances around the periphery of the tube feeder wheel 242. When the tube feeder wheel 242 is rotated in e.g., the counter clockwise direction by a tube feeder wheel drive 245, a stiff tube 101 eventually falls from the tube feeder frame 241 into one of the tube seats of the tube feeder wheel 242 which is positioned at the lower opening of the funnel of the tube feeder frame 241. The tube feeder wheel 242 is then further rotated in the counter clockwise direction until the stiff tube 101 reaches, in the view of FIG. 7a), the leftmost position of the tube feeder wheel 242 in which position the stiff tube 101 is ready for the insertion of the electric cable 100.

The funnel of the tube feeder frame 241 and the funnel of the ring feeder frame 261 each features thin walls on both lateral sides of the funnel (not shown in FIG. 7), in order to prevent the stiff tubes 101 and flexible rings 102 to fall out of the funnel.

The tube feeder wheel 242 is fixed on a wheel axle 243 of the tube feeder unit 255. Rotation of the wheel axle 243 is controlled by the tube feeder wheel drive 245. The torque transfer from the tube feeder wheel drive 245 to the wheel axle 243 is effected by means of a toothed drive wheel 246 of the tube feeder wheel drive 245 and by means of a first toothed belt 247. Between the toothed drive wheel 246 and the wheel axle 243, the first toothed belt 247 runs over a first intermediate toothed wheel 253 of the tube feeder unit 255 (FIGS. 7b) and 7c)) and drives the same. The first intermediate toothed wheel 253 is fixedly attached to an intermediate axle 250 of the tube feeder unit 255, to which also a second intermediate toothed wheel 254 is attached. A second toothed belt 249 runs over the second intermediate toothed wheel 254 as well as over a toothed axle wheel 244 that is fixed on the wheel axle 243 and drives the same. The tube feeder wheel drive 245, the intermediate axle 250 and the wheel axle 243 are attached to a tube feeder intermediate axle frame 251 which, together with the wheel axle support 252, is fixed on the tube feeder frame 241.

The ring feeder unit 256 comprises a ring feeder frame 261 for the storage, supply and guidance of the flexible rings 102 to be applied to the electric cable 100. The flexible rings 102 are guided by a funnel formed by the ring feeder frame 261 to a ring feeder wheel 262 which has specific ring seats for the flexible rings 102. The ring seats are provided in the form of rounded cut-outs that are radially open towards the outside and are provided at regular distances around the periphery of the ring feeder wheel 262. When the ring feeder wheel 262 is rotated in e.g. the clockwise direction by a ring feeder wheel drive 265, a flexible ring 102 eventually falls from the ring feeder frame 261 into one of the ring seats of the ring feeder wheel 262 which is positioned at the lower opening of the funnel of the ring feeder frame 261. The ring feeder wheel 262 is then further rotated in the clockwise direction until the flexible ring 102 reaches, in the view of FIG. 7a), the rightmost position of the ring feeder wheel 262, in which position the flexible ring 102 is aligned with the stiff tube 101 held by the tube feeder wheel 242. Thus, in the state as shown in FIG. 7a), the flexible ring 102 and the stiff tube 101 held by the ring feeder wheel 262 and the tube feeder wheel 242, respectively, are ready for the electric cable 100 to be inserted.

The ring feeder wheel 262 is fixed on a wheel axle 263 of the ring feeder unit 256. Rotation of the wheel axle 263 is controlled by the ring feeder wheel drive 265. The torque transfer from the ring feeder wheel drive 265 to the wheel axle 263 is effected by means of a toothed drive wheel 266 of the ring feeder wheel drive 265 and by means of a first toothed belt 267. Between the toothed drive wheel 266 and the wheel axle 263, the first toothed belt 267 runs over a first intermediate toothed wheel 273 of the ring feeder unit 256 (FIGS. 7b) and 7c)) and drives the same. The first intermediate toothed wheel 273 is fixedly attached to an intermediate axle 270 of the ring feeder unit 256, to which also a second intermediate toothed wheel 274 is attached. A second toothed belt 269 runs over the second intermediate toothed wheel 274 as well as over a toothed axle wheel 264 that is fixed on the wheel axle 263 and drives the same. The ring feeder wheel drive 265, the intermediate axle 270 and the wheel axle 263 are attached to a ring feeder intermediate axle frame 271 which is itself fixed on the ring feeder frame 261.

For the release of the respective part of the tubular hull 120 after insertion and definitive positioning of the electric cable 100, a feeder unit opening drive 280 is provided, in order to move the tube feeder unit 255 and the ring feeder unit 256 apart from each other. This is effected by rotating an opening spindle 281. For this purpose, the opening spindle 281 features a right hand thread in the region underneath the tube feeder unit 255. This right hand thread of the opening spindle 281 engages in a right hand threaded bore provided in the tube feeder frame 241. For the respective movement of the ring feeder unit 256, the opening spindle 281 furthermore features a left hand thread in the region underneath the ring feeder unit 256. This left hand thread of the opening spindle 281 engages in a left hand threaded bore provided in the ring feeder frame 261. The feeder unit opening drive 280 is mounted on the opening drive frame 282. The opening spindle 281 extends through one or several journal bearings 283 fixed in the opening drive frame 282.

In order to hold the stiff tubes 101 and flexible rings 102 in place until the respective part of the tubular hull 120 is released after insertion and definitive positioning of the electric cable 100, the stiff tubes 101 and the flexible rings 102 can additionally be held in place by a vacuum that draws the stiff tubes 101 and the flexible rings 102 towards the tube feeder wheel 242 and the ring feeder wheel 262, respectively. For this purpose, a pressure control unit 294 of the tube feeder unit 255 is exemplary shown in FIG. 7b), which serves for applying a vacuum at the seats of the tube feeder wheel 242, in order to hold and release the stiff tubes 101. Furthermore, a pressure control unit 277 of the ring feeder unit 256 having first and second vacuum connectors 275, 276 for the attachment of respective gas lines is exemplary shown in FIGS. 7a) and 7c). The pressure control unit 277 serves to apply a vacuum at the seats of the ring feeder wheel 262, in order to hold and release the flexible rings 102.

The tube feeder unit 255 and the ring feeder unit 256 together with the opening drive frame 282 are mounted on a base structure 285.

The base structure 285 can serve as a common base for all of the tube and ring feeder units 240 of the tubular hull application unit 200.

In subfigure 7b), a cross section A-A of the tube and ring feeder unit 240 is shown. In this figure, it is particularly shown how the wheel axle 243 of the tube feeder unit 255 is supported by the tube feeder frame 241 and a wheel axle support 252. It is also shown how the wheel axle 263 of the ring feeder unit 256 is supported by the ring feeder intermediate axle frame 271. Furthermore, the provision of several journal bearings 248 and 268 in the tube feeder unit 255 and in the ring feeder unit 256 is shown, in order to bear the wheel axle 243 and the intermediate axle 250 of the tube feeder unit 255 and to bear the wheel axle 263 and the intermediate axle 270 of the ring feeder unit 256, respectively.

Also the arrangement of the toothed drive wheels 246, 266 and of the corresponding toothed belts 247, 267 for the driving of the tube feeder wheel 242 and of the ring feeder wheel 262 are shown in subfigure 7b).

Thus, the embodiment of a tube and ring feeder unit 240 as shown in FIG. 7 operates with a tube feeder wheel 242 and a ring feeder wheel 262 which feature three seats for the stiff tubes 101 and the flexible rings 102, respectively. Of course embodiments with a different number of seats in the tube feeder wheel 242 and the ring feeder wheel 262 are possible.

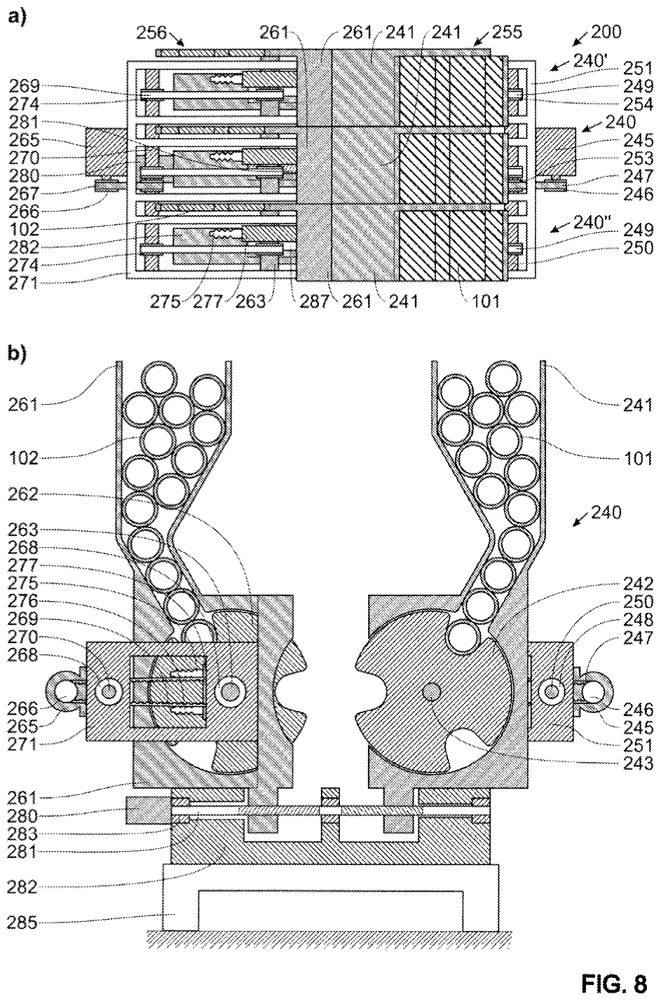

FIG. 8—Further Details and Embodiments of the Tubular Hull Application Unit

In FIG. 8a), an embodiment of a tubular hull application unit 200 having three tube and ring feeder units 240, 240′ and 240″ is shown. The three tube and ring feeder units 240, 240′ and 240″ are arranged directly adjacent to each other such that three stiff tubes 101 and three flexible rings 102 can simultaneously be attached to the electric cable 100 in alternating order. Of course, embodiments with more than three tube and ring feeder units are also conceivable, in order to simultaneously attach even more stiff tubes 101 and flexible rings 102 to the electric cable 100.

The tubular hull application unit 200 as shown in FIG. 8a has a centralised common ring feeder wheel drive 265 and a centralised common tube feeder wheel drive 245.

In order to reduce the amount of drives, a single common intermediate axle 250 is provided for the tube feeder units 255 of all three tube and ring feeder units 240, 240′ and 240″. The rotation of the toothed drive wheel 246 of the tube feeder wheel drive 245 is transferred, via the first toothed belt 247, to the common intermediate axle 250 and from there, via respective second toothed belts 249, to the wheel axle 243 and, thus, to the tube feeder wheel 242 of each tube and ring feeder unit 240, 240′ and 240″. Likewise, a single common intermediate axle 270 is provided for the ring feeder units 256 of all three tube and ring feeder units 240, 240′ and 240″. The rotation of the toothed drive wheel 266 of the ring feeder wheel drive 263 is transferred, via the first toothed belt 267, to the common intermediate axle 270 and from there, via respective second toothed belts 269, to the wheel axle 263 and, thus, to the ring feeder wheel 262 of each tube and ring feeder unit 240, 240′ and 240″.

In other embodiments, it is also possible to have several common ring feeder wheel drives 265 and several common tube feeder wheel drives 245 which each serve to drive a plurality of tube feeder wheels 242 and a plurality of ring feeder wheel 262, respectively.

As can be seen in a combined view of FIGS. 8a) and 8b), also the feeder unit opening drive 280 is centralised. This is achieved by providing a common ring feeder intermediate axle frame 271 which connects the three ring feeder units 256 mechanically and by applying a common tube feeder intermediate axle frame 251 which connects the three tube feeder units 255 mechanically. In this way, all three tube feeder units 255 and all three ring feeder units 256 can be moved apart from each other by means of only a single feeder unit opening drive 280 having a single centrally arranged opening spindle 281. In order to achieve a linearly well guided movement of the two outer tube and ring feeder units 240′ and 240″, each of these two tube and ring feeder units 240′ and 240″ has a guide rod 287 with a plane surface extending through bearing bushes provided in the tube feeder frame 241 and in the ring feeder frame 261, respectively.

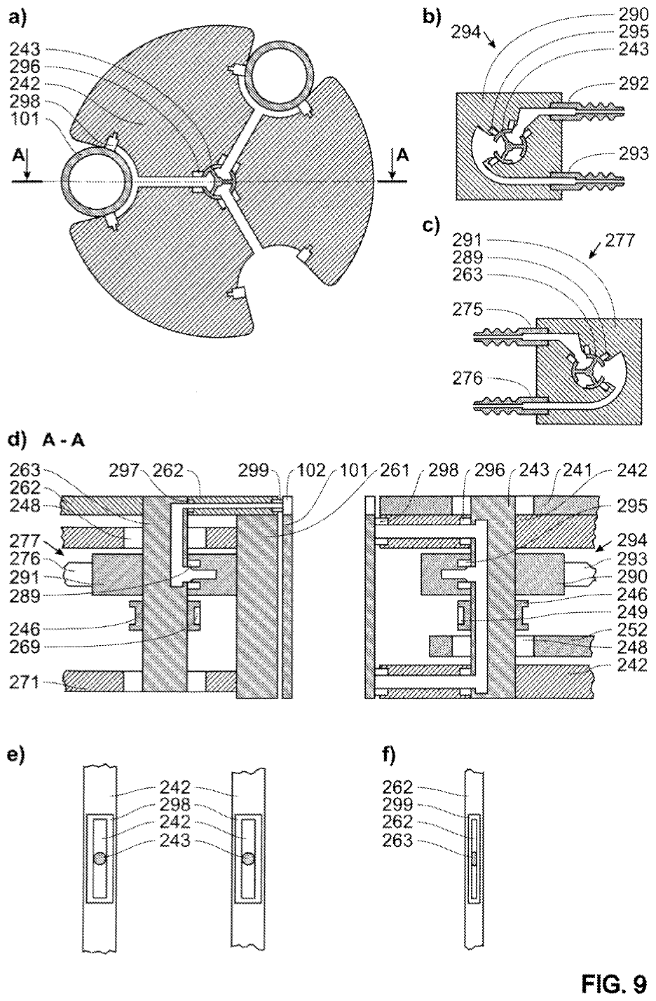

FIG. 9—Details of a Vacuum Control Unit

In FIG. 9, the parts of the vacuum fixation for the stiff tubes 101 and flexible rings 102 of the tube and ring feeder unit 240 are shown.

In subfigure 9a), as an example, the tube feeder wheel 242 of the tube feeder unit 255 with integrated seat sealing elements 298 is shown. The same configuration can also be provided for the ring feeder wheel 262 in an analogous manner.

In order to hold the stiff tubes 101 and flexible rings 102 in place until the respective part of the tubular hull 120 is released after insertion and definitive positioning of the electric cable 100, the stiff tubes 101 and flexile rings 102 are held in place by vacuum. Also for picking up the stiff tubes 101 from the supply in the tube feeder frame 241 or for picking up of the flexible rings 102 from the supply in the ring feeder frame 261, the application of a vacuum in the area of the seats of the tube feeder wheel 242 or the ring feeder wheel 262 can support a reliable operation.

In order to obtain a desired pressure in the seats of the tube feeder wheel 242 (or of the ring feeder wheel 262), a respective gas line extends from an opening in each seat to the wheel axle 243. As shown in FIG. 9a), the wheel axle 243 comprises, in cross section, three gas rooms which are separated from each other in a gastight manner. Each of these gas rooms is connected to one of the seats of the tube feeder wheel 242 via a respective gas line. Scaling elements 296 are provided for connecting the gas rooms to the gas lines in a gas-tight manner. By applying e.g. a vacuum to one or several of these three gas rooms of the wheel axle 243, a vacuum can be established at one or several specific seats of the tube feeder wheel 242.

The supply of a vacuum (or of an overpressure or atmospheric pressure, in order to release the stiff tubes 101) to the wheel axle 243 of the tube feeder unit 255 is established by the pressure control unit 294 of the tube feeder unit 255, shown in FIG. 9b). To achieve separate control of the pressure at different seats of the tube feeder wheel 242, separate first and second vacuum connectors 292, 293 are provided at a case 290 of the pressure control unit 294. The first and second vacuum connectors 292, 293 serve to guide separate gas lines to different gas rooms of the wheel axle 243. Depending on the rotational position of the wheel axle 243 and on the type of lines that are connected to the first and second connectors 292 and 293, the different gas rooms in the wheel axle 243 are supplied with either a vacuum, atmospheric pressure or even an overpressure. Scaling elements 295 are provided to seal the wheel axle 243 against the case 290 in a gas-tight manner.

The supply of a vacuum (or of an overpressure or atmospheric pressure, in order to release the flexible rings 102) to the wheel axle 263 of the ring feeder unit 256 is established by the pressure control unit 277 of the ring feeder unit 256, shown in FIG. 9c). To achieve separate control of the pressure at different seats of the ring feeder wheel 262, separate first and second vacuum connectors 275, 276 are provided at a case 291 of the pressure control unit 277. The first and second vacuum connectors 275, 276 serve to guide separate gas lines to different gas rooms in the wheel axle 263. Depending on the rotational position of the wheel axle 263 and on the type of lines that are connected to the first and second connectors 275 and 276, the different gas rooms in the wheel axle 263 are supplied with either a vacuum, atmospheric pressure or even an overpressure. Scaling elements 289 are provided to seal the wheel axle 263 against the case 291 in a gas-tight manner.

Subfigure 9d) shows a cross section through the line A-A shown in FIGS. 7a) and 9a) of the tube and ring feeder unit 240 of FIG. 7a) with a tube feeder wheel 242 and a ring feeder wheel 262 which are each designed as the one in FIG. 9a). Here, the gas flow paths to the seats of the tube feeder wheel 242 and of the ring feeder wheel 262 are shown, which enable to hold and release the stiff tubes 101 and the flexible rings 102.

By applying a vacuum at the second vacuum connector 276 of the pressure control unit 277 of the ring feeder unit 256, a vacuum gas flow can be conducted via the case 291 to the gas room of the wheel axle 263 which is connected to the rightmost seat of the ring feeder wheel 262 as shown in FIG. 7a). The respective seat holds the flexible ring 102 in such a position that the electric cable 100 is ready to be inserted. The insertion of the electric cable 100 results in a substantial force acting on the flexible ring 102. The flexible ring 102 is, however, held in place by means of the applied vacuum. The gas flow connection from the ring feeder wheel axle 263 to the seats of the ring feeder wheel 262 is sealed by sealing elements 297. The seats of the ring feeder wheel 262 are sealed in each case against the flexible ring 102 inserted therein by means of seat sealing elements 299.

By applying a vacuum at the second connector 293 of the pressure control unit 294 of the tube feeder unit 255, a vacuum gas flow can be conducted via the case 290 to the gas room of the wheel axle 243 which is connected to the leftmost seat of the tube feeder wheel 242 as shown in FIG. 7a). The respective seat holds the stiff tube 101 in such a position that the electric cable 100 is ready to be inserted. The insertion of the electric cable 100 results in a substantial force acting on the stiff tube 101. The stiff tube 101 is, however, held in place by means of the applied vacuum. The gas flow connection from the tube feeder wheel axle 243 to the seats of the tube feeder wheel 242 is sealed by sealing elements 296. The seats of the tube feeder wheel 242 are sealed in each case against the stiff tube 101 inserted therein by means of seat scaling elements 298.

In subfigure 9e), a view onto the periphery of the tube feeder wheel 242 in the region of one of the seats for a stiff tube 101 is shown. Here, a possible shape of the seat sealing element 298 is shown which is provided twice per seat due to a splitting up of the tube feeder wheel 242 into two parts along a vertical plane, as shown in FIG. 9d).

In subfigure 9f), a view onto the periphery of the ring feeder wheel 262 in the region of one of the seats for a flexible ring 102 is shown. Here, a possible shape of the seat sealing element 299 is shown.

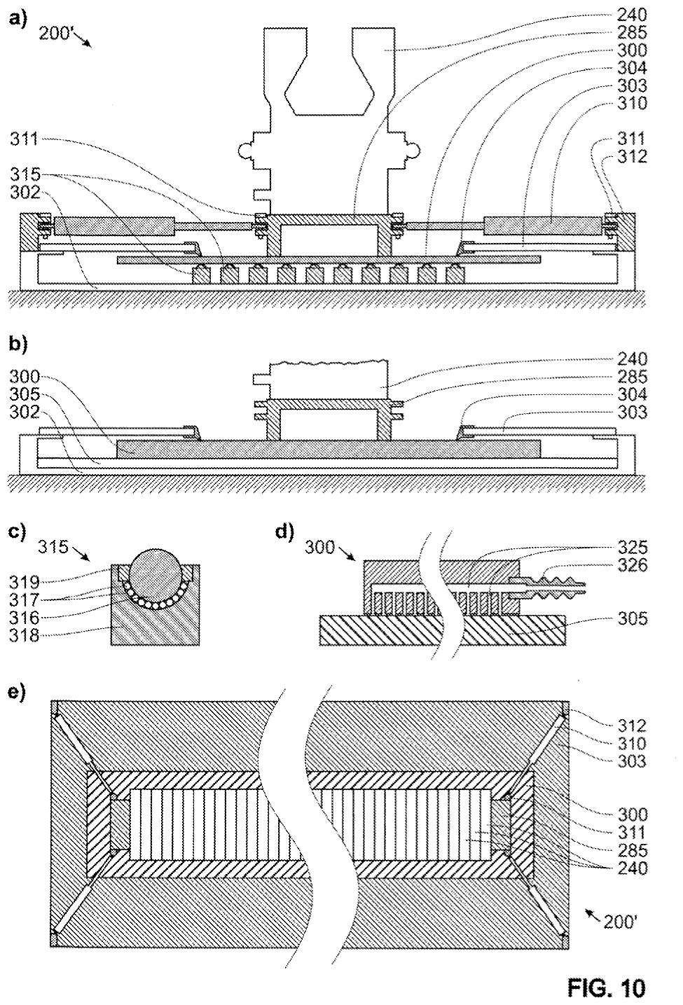

FIG. 10—Details and Embodiments of a Tubular Hull Application Unit for Use with Rotary Drum Units

FIG. 10 shows a possible embodiment for implementing a moveable base plate, in order to obtain a tubular hull application unit 200′ as shown in FIG. 4 that is not fixed in position, but moveable. The embodiment of a tubular hull application unit 200′ as shown in FIG. 10 is moveable, in order to provide an optimal spooling and unspooling process during the application of the tubular hull 120 to the electric cable 100 by means of the rotary drum units 3 as shown in FIG. 4.

In the embodiment of FIG. 10, a plurality of tube and ring feeder units 240 are arranged directly adjacent to each other (see FIG. 10e)). Linear actuators 310 are provided to position the plurality of tube and ring feeder units 240 in such a way that the electric cable 100 extending there through is not deflected in the region between the two rotary drum units 3. The linear actuators 310 thus serve to support the rotational motion about the vertical axis caused by the spooling and unspooling process of the rotary drum units 3 as explained further above with respect to FIG. 4.

As shown in FIG. 10a), each of the four linear actuators 310 is connected with a base fixation 312 which is fixedly arranged in one of the four corners of a stationary base plate 302. In each case, the linear actuators 310 extend from one of these base fixations 312 to a corner of the base structure 285. At the base fixation 312 and at the corner of the base structure 285, the linear actuator 310 is connected by means of a fixation bolt 311 in each case. The fixation bolts 311 represent elements of rotary joints, such that in these joints, the linear actuators 310 are basically freely rotatable in the horizontal plane.

Thus, the motion of the tube and ring feeder units 240 is controlled by the linear actuators 310 which are able to change the position and orientation of the base structure 285 with respect to the stationary base plate 302 in a precisely controlled way.

The tube and ring feeder units 240 are all mounted on the base structure 285 which itself is mounted on a moveable base plate 300. The moveable base plate 300 bears on rolling ball bearings 315, such that a substantially friction-free movement of the tube and ring feeder units 240 relative to the stationary base plate 302 is achieved.

A dust protection plate 303 is fixed on the stationary base plate 302 in such a way, that the movable base plate 300 is arranged between the dust protection plate 303 and the stationary base plate 302, in combination with dust sealing elements 304, the dust protection plate 303 protects the rolling ball bearings 315 from dust and also provides protection against accidents by means of covering most parts of the moveable base plate 300.

In the embodiment of FIG. 10b), another principle is shown to provide a substantially friction-free movement of the base structure 285 with the tube and ring feeder units 240 relative to the stationary base plate 302. The moveable base plate 300 on which the base structure 285 is fixed bears on a gliding plate 305. The gliding plate 305 is fixed on the stationary base plate 302. A movement with minimal friction of the movable base plate 300 relative to the gliding plate 305 can be achieved on the basis of a suitable material combination. e.g. polished steel versus polytetrafluorethylene, or on the basis of an oil film or a pressurised air film layer between the two plates 300 and 305. By minimizing the friction for the movement of the tube and ring feeder units 240 relative to the stationary base plate 302, the energy consumption during the spooling/unspooling-process can be reduced.

In FIG. 10c), a possible design of the rolling ball bearing 315 is shown. A large rolling ball 316 is rolling on a hemispherical layer of small rolling balls 317 which is arranged in a rolling ball bearing support 318. In order to prevent the large rolling ball 316 from exiting out of its position and in order to prevent dust particles from entering the space between the large rolling ball 316 and the small rolling balls 317, an annular sealing element 319 is arranged around the large rolling ball 316.

In FIG. 10d), a possible design of an oil or pressurised air film bearing is shown, comprising the moveable base plate 300 and the gliding plate 305. The moveable base plate 300 here comprises a plurality of channels 325 which serve for transportation of air or fluid to the space between the movable base plate 300 and the gliding plate 305, in order to establish a low friction air or fluid film between the plates 300, 305. The medium in the form of air or fluid is supplied to the channels 325 via a medium connector 326.

In FIG. 10e), a top view of a possible embodiment of the tubular hull application unit 200′ is shown. It can be seen that the tubular hull application unit 200′ comprises numerous tube and ring feeder units 240 lined up in a row for the application of the tubular hull 120 to the electric cable 100.

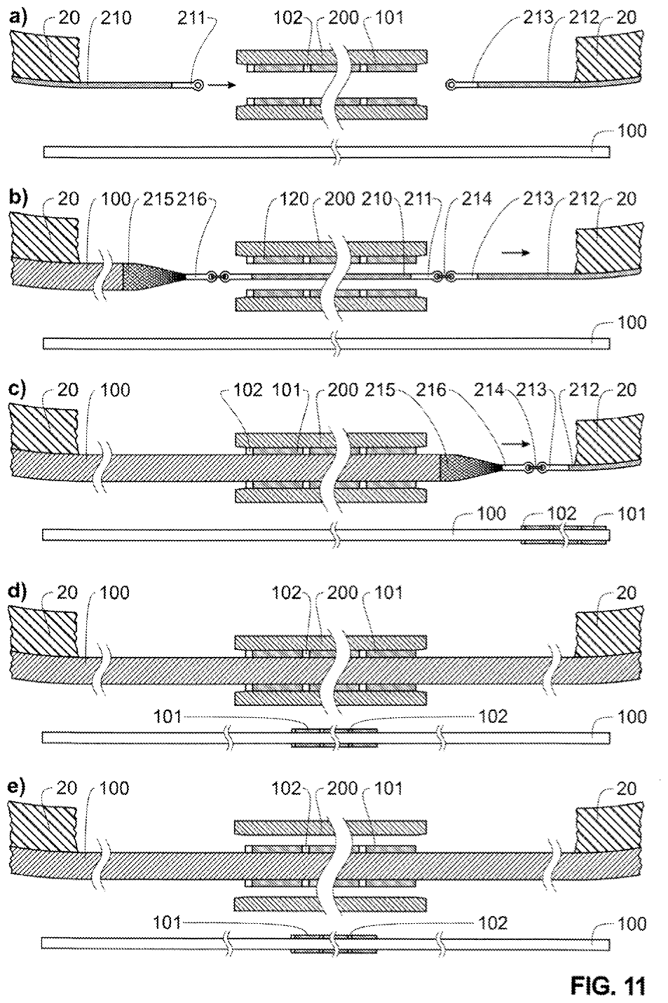

FIG. 11—First Part of the Tubular Hull Application Process

FIGS. 11 to 15 illustrate the tubular hull application process in which stiff tubes 101 and flexible rings 102 are applied in alternating order to the electric cable 100 by means of the tubular hull application device 1. The specific process steps taking place using the tubular hull application unit 200 and the drums 20 are shown in the top part of subfigures a), b), c), d) and e) of each of FIGS. 11 to 15. In order to illustrate the progress of the tubular hull application process, the electric cable 100 is additionally shown along of its entire length in schematic form in the bottom part of subfigures a), b), c), d) and e) of each of FIGS. 11 to 15.

In FIG. 11a), the tubular hull application unit 200 is in its starting position, in which a plurality stiff tubes 101 and flexible rings 102 have been aligned by means of the tube and ring feeder units 240, in order to form a part of the tubular hull 120. Thus, the tubular hull application unit 200 is ready for the insertion of the electric cable 100 into the pre-aligned stiff tubes 101 and flexible rings 102.

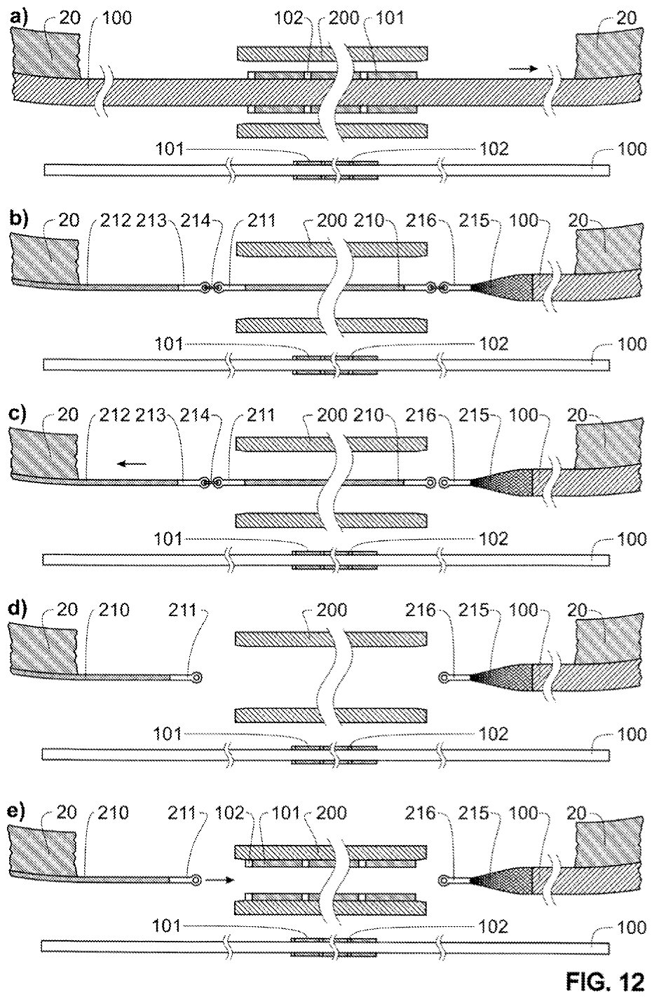

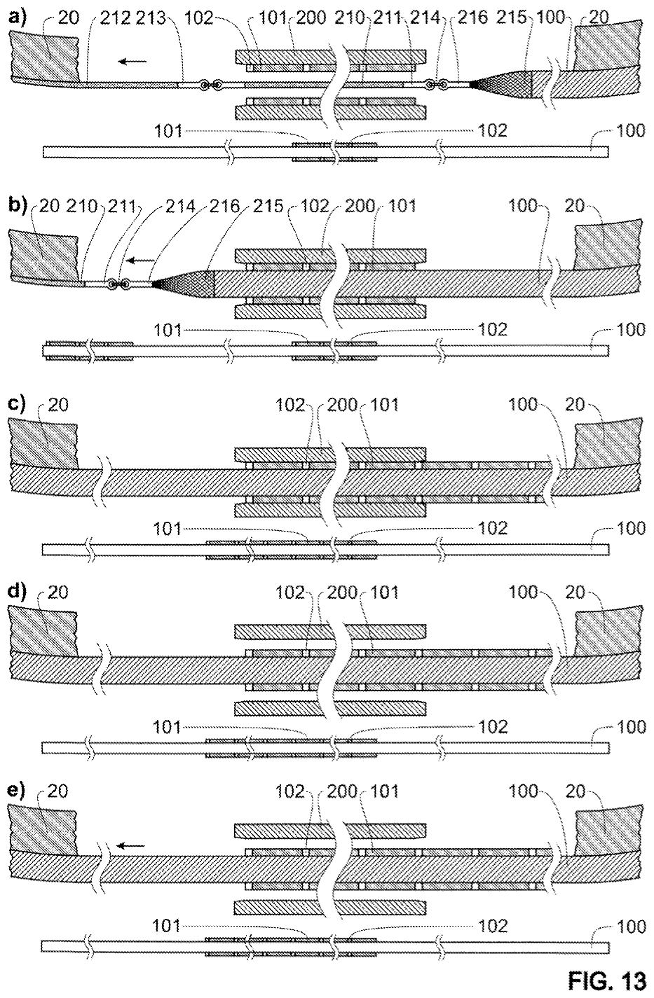

On the left side of FIG. 11a), a part of the drum 20 as well as a pull-in rod 210 with a first end having a pull-rod end connection 211 are shown. The pull-in rod 210 is spooled on the drum 20 and has a second end to which a first end of the electric cable 100 (not shown in FIG. 11a), but shown in FIGS. 11b-c)) is connected. The electric cable 100 is wound along of its entire length around the drum 20. The second end of the electric cable 100 is connected to a further pull-in rod 210 which is then connected to a drum connection rope 212. The further pull-in rod 210 and the drum connection rope 212 are shown in FIGS. 12 and 13, but not in FIG. 11. The drum connection rope 212 is then connected to the drum 20.

On the right side of FIG. 11b), a part of the drum 20 is shown around which another drum connection rope 212 is wound up. The drum connection rope 212 comprises a first end having a rope end connection 213. The second end of the drum connection rope 212 is connected to the drum 20.

In the bottom part of FIG. 11a), it is shown that in the starting position of the tubular hull application unit 200, no stiff tubes 101 and flexible rings 102 are applied to the electric cable 100 along of its entire length yet.

After having taken the starting position, in the first step of the hull application process as shown in FIG. 11b), the pull-in rod 210 attached to the drum 20 via the electric cable 100 on the left side in the figure is inserted into the part of the tubular hull 120 prepared by the tubular hull application unit 200. The first pull-in rod end connection 211 is connected to the rope end connection 213 by means of a connection element 214.

The length of the pull-in rod 210 is adapted to the length of the part of the tubular hull 120 prepared by the tubular hull application unit 200, i.e. to the respective length of the plurality of tube and ring feeder units 240.

As can be seen in FIG. 11b), the electric cable 100 comprises, at its first end and at its second end (not shown in FIG. 11b), but in e.g. FIG. 12b)), a pulling head 215 for the controlled axial force transfer to the entire cross section of the electric cable 100. For the mechanical connection of the pulling head 215 to the pull-in rod 210, a pulling head end connection 216 is fixed to the pulling head 215. The pulling head end connection 216 is connected to the pull-in rod 210 by means of a connection element 214.

FIG. 11c) shows the next step of the hull application process, in which the first end of the electric cable 100 is pulled through the prepared part of the tubular hull 120 by means of a spooling operation of the drums 20 towards the right side in the view of FIG. 11c).

In the bottom part of FIG. 11c), it is shown that now the respective part of the tubular hull 120 is applied to a first end part of the electric cable 100.

As shown in FIG. 11d), the electric cable 100 is pulled further through the tubular hull application unit 200 by means of a spooling operation of the drums 20 until the part of the tubular hull 120 is positioned in the middle of the electric cable 100. The arrangement of the respective part of the tubular hull 120 in the middle of the electric cable 100 is particularly visualized in the bottom part of FIG. 11d).

In FIG. 11e), the tubular hull application unit 200 is then brought in its open position as illustrated in FIG. 8b).

FIG. 12—Second Pan of the Tubular Hull Application Process

In FIG. 12a), the electric cable 100 with a plurality of stiff tubes 101 and flexible rings 102 applied to the middle thereof is spooled onto the drum 20 shown on the right side of the figure.

In FIG. 12b), the electric cable 100 together with the stiff tubes 101 and flexible rings 102 applied thereto is wound entirely around the drum 20 shown on the right side of the figure. The pull-in rod 210 connected to the second end of the electric cable 100 is extending through the hull application unit 200. The drum connection rope 212 is now visible which connects this pull-in rod 210 with the drum 20 arranged on the left side in the view of FIG. 12b).

According to FIG. 12c), the connection element 214 between the electric cable 100 and the pull-in rod 210 is then removed.

In FIG. 12d), the next step of the process is shown in which the pull-in rod 210 is completely pulled out of the tubular hull application unit 200 and spooled onto the drum 20 shown on the left side of the figure. The stiff tubes 101 and flexible rings 102 are still applied to the middle of the electric cable 100 as shown in the bottom part of FIG. 12d).

As shown in FIG. 12e), the tubular hull application unit 20) is then brought in its closed position and a new set of stiff tubes 101 and flexible rings 102 is aligned and prepared by the tube and ring feeder units 240, in order to form a further part of the tubular hull 120.

FIG. 13—Third Part of the Tubular Hull Application Process

In FIG. 13a), it is shown that the pull-in rod 210 is inserted back into the tubular hull application unit 200 and connected with the pull-in rod end connection 211 to the pulling head end connection 216 of the electric cable 100 by means of the connection element 214. The electric cable 100 is still wound up on the drum 20 shown on the right side of the figure.

In FIG. 13b), the second end of the electric cable 100 is pulled back into the tubular hull application unit 200 by means of a spooling operation of the drums 20.

As shown in FIG. 13c), the electric cable 100 is pulled further into the tubular hull application unit 200 until the new set of stiff tubes 101 and flexible rings 102 as prepared by the tubular hull application unit 200 is positioned directly adjacent to the stiff tubes 101 and flexible rings 102 which have already been applied to the middle of the electric cable 100 in the previous process steps.

In the bottom part of FIG. 13c), it is visualized that the new set of stiff tubes 101 and flexible rings 102 is now applied to the electric cable 100 directly adjacent to the stiff tubes 101 and flexible rings 102 which have been applied to the middle of the electric cable 100 in the previous process steps.

The hull application unit 200 is then brought in the open position as illustrated in FIG. 13d).

According to FIG. 13e), the electric cable 100 with the stiff tubes 101 and flexible rings 102 applied thereto is then spooled onto the drum 20 shown on the left side of the figure.

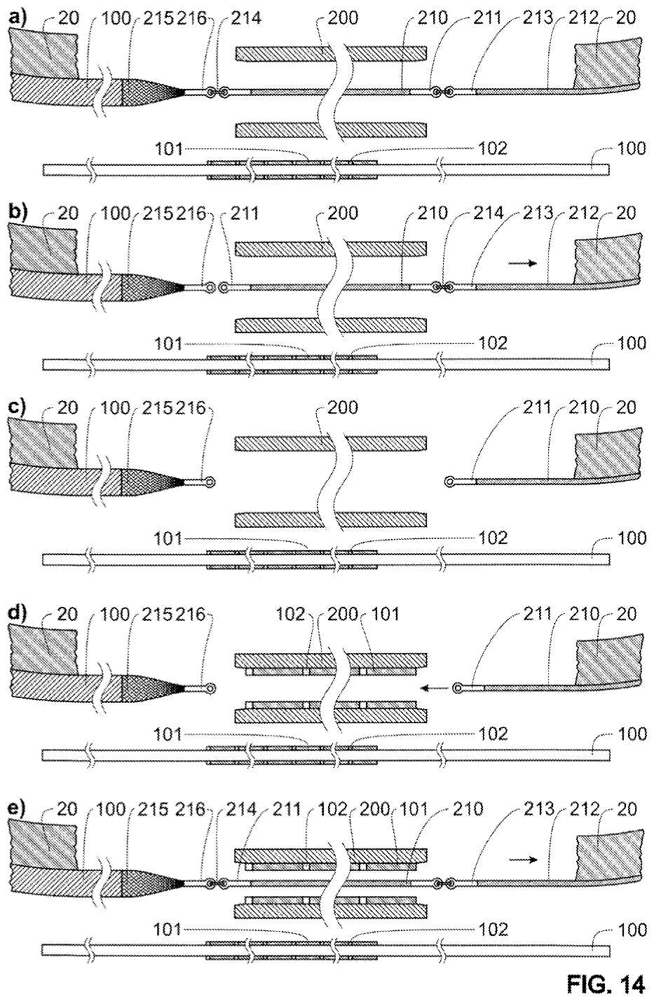

FIG. 14—Fourth Part of the Tubular Hull Application Process

In FIG. 14a), the electric cable 100 together with the stiff tubes 101 and flexible rings 102 applied thereto is almost completely wound up on the drum 20 shown on the left side of the figure. The pull-in rod 210 connected to the first end of the electric cable 100 is now visible as well as the drum connection rope 212 connecting this pull-in rod 210 to the drum 20 shown on the right side of the figure.

According to FIG. 14b), the connection element 214 between the electric cable 101) and the pull-in rod 210 is then removed.

In FIG. 14c), the next step of the process is shown in which the pull-in rod 210 is completely pulled out of the tubular hull application unit 200 and spooled onto the drum 20 shown on the right side of the figure. The stiff tubes 101 and flexible rings 102 are still applied to the middle region of the electric cable 100 as shown in the bottom part of FIG. 14c).

As shown in FIG. 14d), the tube and ring feeder units 240 of the tubular hull application unit 200 are then brought in their closed position and another new set of stiff tubes 101 and flexible rings 102 is aligned and prepared by the tube and ring feeder units 240, in order to form another further part of the tubular hull 120.

In FIG. 14e), it is shown that the pull-in rod 210 is inserted back into the tubular hull application unit 200 and connected with the pull-in rod end connection 211 to the pulling head end connection 216 of the electric cable 100 by means of the connection element 214. The electric cable 100 is still wound up on the drum 20 shown on the left side of the figure.

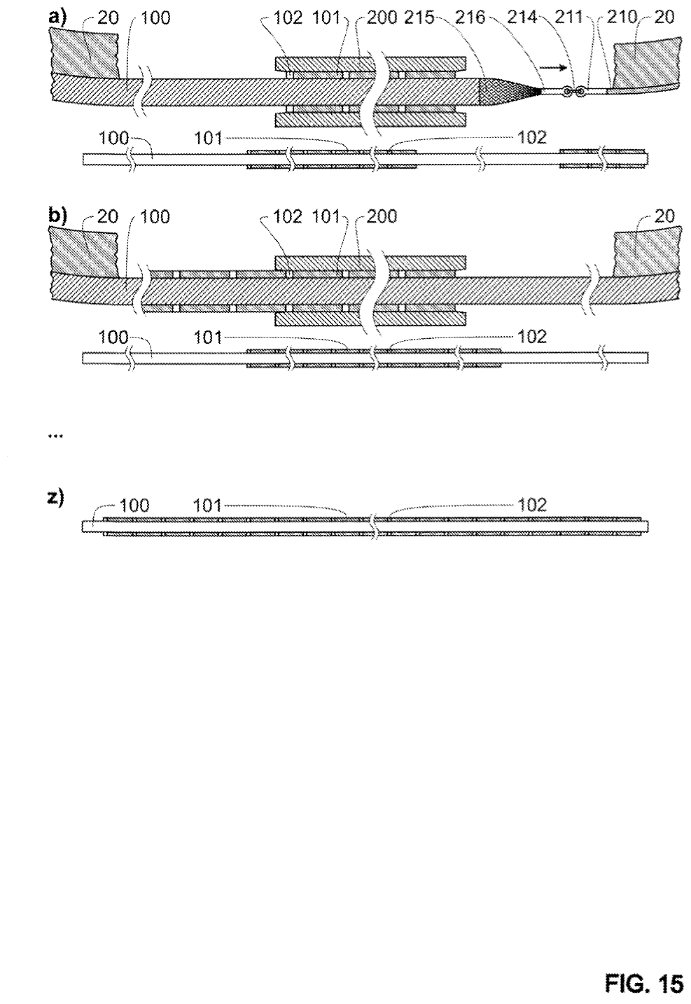

FIG. 15—Fifth Part of the Tubular Hull Application Process

In accordance to FIG. 15a), the first end of the electric cable 100 is pulled through the tubular hull application unit 200 by means of a spooling operation of the drums 20.

In FIG. 15b), the electric cable 100 is pulled further into the tubular hull application unit 200 until the new set of stiff tubes 101 and flexible rings 102 as prepared by the tubular hull application unit 200 is positioned directly adjacent to the stiff tubes 101 and flexible rings 102 which have already been applied to the middle region of the electric cable 100 in the previous process steps.

In bottom part of FIG. 15b), it is visualized that the new set of stiff tubes 101 and flexible rings 102 is now applied to the electric cable 100 directly adjacent to the stiff tubes 101 and flexible rings 102 which have been applied to the middle region of the electric cable 100 in the previous process steps.

The process steps as illustrated in FIGS. 11c) to 15b) are then repeated until essentially the entire length of the electrical cable 100 is covered with stiff tubes 101 and flexible rings 102 as shown in FIG. 15.).

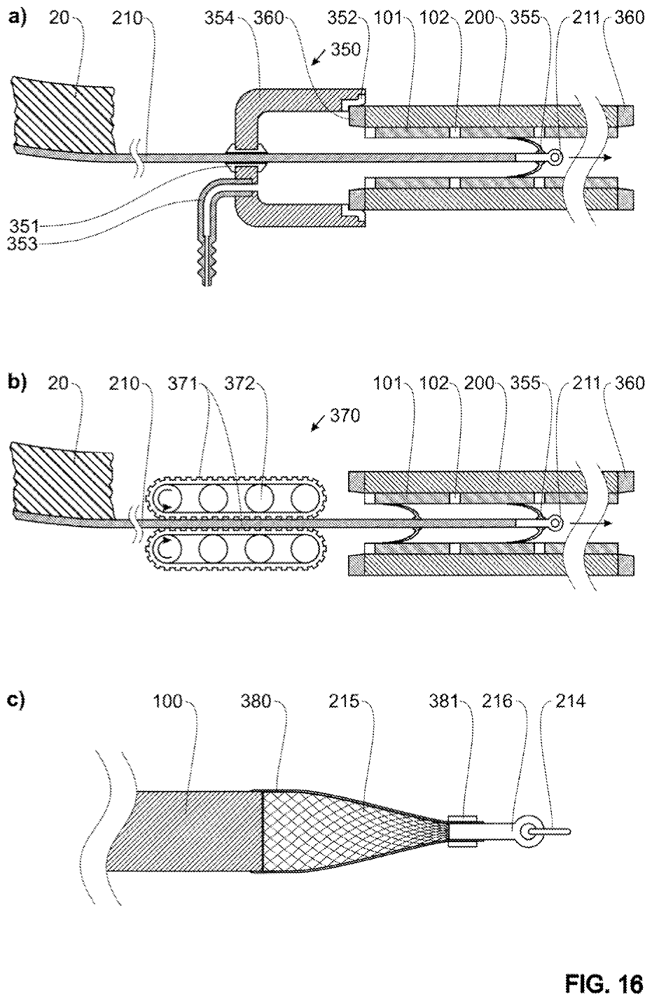

FIG. 16.—Insertion of the Pull-in Rod into the Tubular Hull Application Unit

FIG. 16 shows possible embodiments for facilitating the insertion of the pull-in rods 210 into the tubular hull application unit 200.

In FIG. 16a), an embodiment is shown in which the insertion of the pull-in rod 210 into the tubular hull application unit 200 with a prepared part of the tubular hull 120 is based on the application of pressurised air.

For this purpose, at each end of the tubular hull application unit 200, a closing ring 360 with slightly conical inner surface can be provided. The conical inner surface of the closing rings 36) widens towards the outside in each case, in order to enable an easier insertion of the electric cable 100 with the stiff tubes 101 and flexible rings 102 during the tubular hull application process.

For inserting the pull-in rod 210 into the tubular hull application unit 200, a compressed air insertion unit 350 is provided which comprises a cup-shaped main body 354. The main body 354 comprises a central opening for guiding the pull-in rod 210 there through. Attached to this opening is a sealing element 351 for sealing the main body 354 against the pull-in rod 210 with minimal friction. The main body 354 and the sealing element 351 can optionally be split up in two parts for the easy insertion of the pull-in rod 210.

The compressed air insertion unit 350 is attached to an end of the tubular hull application unit 200 in such a way that it is scaled against the closing ring 360. For this purpose, an annular sealing element 352 can be attached to the main body 354.

A centering element 355 is attached to the end of the pull-in rod 210, in order to provide gas-tightness within the partial tubular hull 120 formed by the prepared stiff tubes 101 and flexible rings 102. In this way, the centering element 355, together with the main body 354 and the partial tubular hull 120 formed by the prepared stiff tubes 101 and flexible rings 102, forms an essentially air-tight inner space. This inner space can be pressurized by means of air or any other gas supplied through an inlet gas connector 353 which is attached to the main body 354. Due to the centering element, the pull-in rod 210 is also centered in the partial tubular hull 120 formed by the stiff tubes 101 and flexible rings 102. The centering element 355 can be made for example of a flexible thermoplastic or a silicone-rubber material with low surface-friction properties.

The pressurised air applied at the inlet gas connector 353 provides a force to the pull-in rod 210 that results in a movement of the pull-in rod 210 into the tubular hull 120. This movement of the pull-in rod 210 into the tubular hull 120 is synchronized with the rotation of the drums 20.

In FIG. 16b), another embodiment for the insertion of the pull-in rod 210 into the prepared partial tubular hull 120 is illustrated. The insertion is here achieved by pushing the pull-in rod 210 forward into the tubular hull application unit 200 by means of a linear conveying device 370.

In combination with the linear conveying device 370, one or several centering elements 355 can be provided, in order to center the pull-in rod 210 in the partial tubular hull 120 made of stiff tubes 101 and flexible rings 102. By applying one or several centering elements 355, a bending of the pull-in rod 210 within the partial tubular hull 120 can be minimized.

Thus, the pull-in rod 210 is pushed into the tubular hull application unit 200 by means of the linear conveying device 370. For this purpose, the linear conveying device 370 can comprise at least two crawler bands 371 which are positioned on either sides of the pull-in rod 210, such as to bear against the latter. The crawler bands 371 are driven by crawler wheels 372, the motion of which is synchronized with the rotation of the drums 20.

In FIG. 16c), an embodiment of a pulling head protection layer 380 is shown that serves for the protection of the inner surface of the tubular hull 120 against scratches from the pulling head 215 of the electric cable 100. The pulling head protection layer 380 covers the pulling head 215 and is fixed to the pulling head end connection 216 by means of e.g. a clamping fixation 381.

In order to provide low friction when the pulling head 216 together with the electric cable 100 is pulled into the tubular hull 120, the pulling head protection layer 380 can be made for example of a low surface-friction material like polytetrafluorethylene. Avoiding scratches on the inner surface of the tubular hull 120 helps to optimize the fatigue life of the tubular hull 120, in particular of the stiff tubes 101.

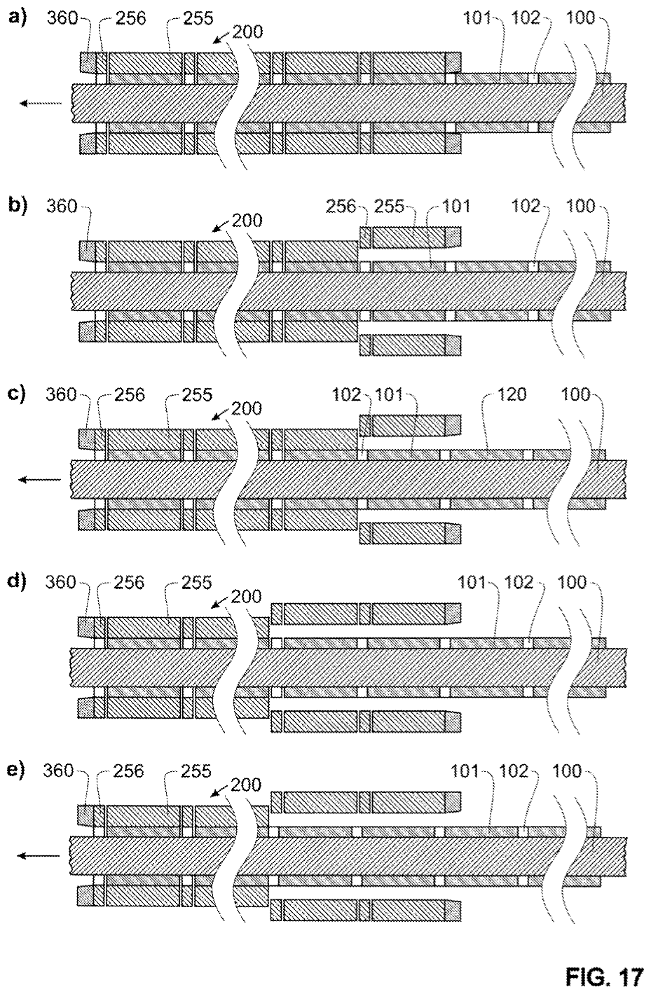

FIG. 17—Compaction Process

In FIG. 17, process steps for an optional compaction of the tubular hull 120 are shown. In case it is required. e.g. for an optimized function of the tether 170, that the stiff tubes 101 and the flexible rings 102 of the tubular hull 120 are packed very tightly against each other, or that even a slight pre-strain is present resulting in a slight squeezing of the flexible rings 102 between the stiff tubes 101, the compaction process described in FIG. 17 can be applied.

As will be explained in the following, the compaction process is generally based on a consecutive release of stiff tubes 101 and flexible rings 102 by the tube and ring feeder unit 240 in combination with a linear pulling movement of the electric cable 100 taking place after each release of a stiff tube 101 and a flexible ring 102.

In FIG. 17a), a partial tubular hull 120 comprising stiff tubes 101 and flexible rings 102 and applied to the electric cable 100 is shown. Some of the stiff tubes 101 and flexible rings 102 are still fixed in the tubular hull application unit 200 after having been positioned on the electric cable 100 adjacent to further stiff tubes 101 and flexible rings 102.

As it is illustrated in FIG. 17a), the stiff tubes 101 and flexible rings 102 that are not fixed in the tubular application unit 200, i.e. the ones that have already been positioned on the electric cable 100 beforehand, are already compacted against each other. The stiff tubes 101 and flexible rings 102 which are still fixed in the tubular hull application unit 200, however, are not yet compacted against each other. Instead, small gaps are present between these stiff tubes 101 and the flexible rings 102.

In FIG. 17b), the rightmost (in the view of FIG. 17b)) tube and ring feeder unit 240 of the tubular hull application unit 200 is opened, in order to release the corresponding stiff tube 101 and flexible ring 102.

In FIG. 17c), the electric cable 100 is pulled to the left side (in the view of FIG. 17c)), resulting in a compaction between the stiff tubes 101 and flexible rings 102 still fixed in the tubular hull application unit 200 and the adjacent stiff tube 101 and flexible ring 102 which have just been released in the process step shown in FIG. 17b).

In FIG. 17d), the tube and ring feeder unit 240 arranged on the left (in the view of FIG. 17d)) of the already opened tube and ring feeder unit 240 of the tubular hull application unit 200 is also opened, in order to release the corresponding stiff tube 101 and flexible ring 102.

In FIG. 17e), the electric cable 100 is pulled to the left side (in the view of FIG. 17e)), resulting in a compaction between the stiff tubes 101 and flexible rings 102 still fixed in the tubular hull application unit 200 and the adjacent stiff tube 101 and flexible ring 102 which have just been released in the process step shown in FIG. 17d).

By repeating the above described process steps, the tubular hull 120 can be compacted along of its entire length.

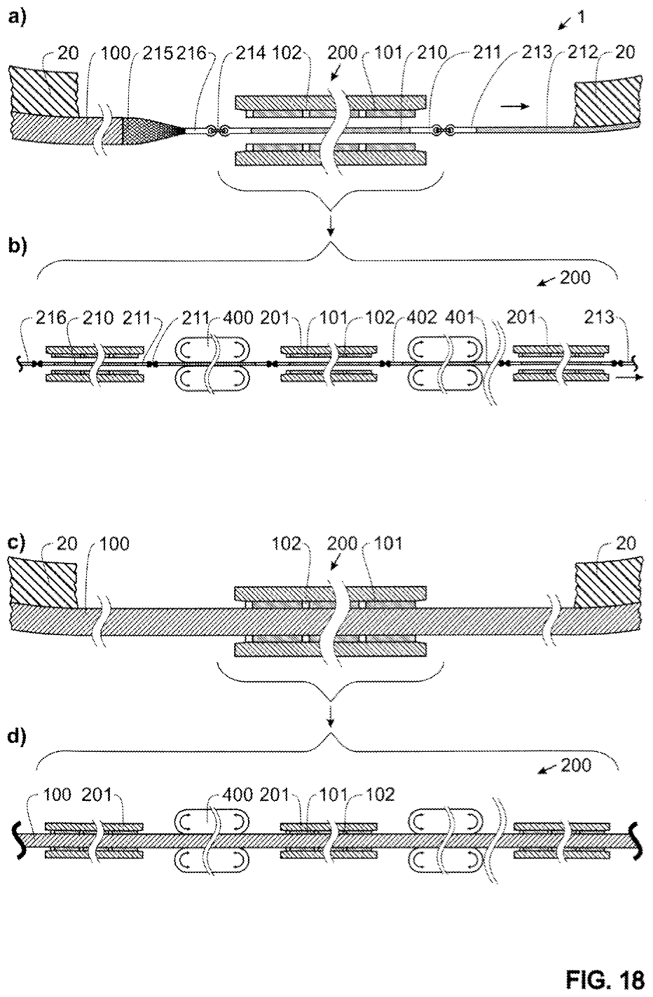

FIG. 18—Use of multiple tubular hull application units

In FIG. 18, a configuration of a tubular hull application device 1 comprising a tubular hull application unit 200 with a plurality of tubular hull application subunits 201 is shown.

In order to reduce the amount of spooling and unspooling processes of the drums 20 and to achieve a reduction of the required time for the application of the tubular hull 120 to the electric cable 100, the tubular hull 120 can simultaneously be applied to the electric cable 100 by means of multiple tubular hull applications subunits 201.

As is explained further above with respect to FIG. 2, the application process of the tubular hull 120 to the electric cable 100 has to be adapted to the maximal allowed pulling force for the electric cable 100. Therefore, for most applications, the process needs to be subdivided into several consecutive applications of parts of the tubular hull 120 along the length of the electric cable 100, in order to not damage the electric system.

In order to deal with these limitations caused by the maximal allowed pulling force for the electric cable 100, intermediate conveying devices 400 can be arranged between e.g. each pair of two consecutive tubular hull application subunits 201. In this way, the total pulling force is subdivided such as to no exceed the maximal allowed pulling force for the electric cable 100 in any of the tubular hull application subunits 201. The several tubular hull application subunits 201 form the tubular hull application unit 200 together with the intermediate conveying devices 400. The movement of the intermediate conveying devices 400 is synchronized with the rotation of the drums 20.

In FIG. 18a), the same configuration of a tubular hull application device 1 is shown like in FIG. 11b).

The process to apply a part of the tubular hull 120 to the electric cable 100, is now subdivided in FIG. 18b) into a plurality of tubular hull application subunits 201 in combination with intermediate conveying devices 400, which allows the simultaneous application of a greater number of stiff tubes 101 and flexible ring 102 to the electric cable 100 as compared to the configuration shown in FIG. 18a).

For the insertion of the intermediated conveying devices 400, intermediate rods 401 with intermediate end connections 402 are provided.

The process step shown in FIG. 18c) with the tubular hull application unit 200 having one subunit only corresponds to the process step shown in FIG. 18d) with multiple tubular hull applications subunits 201. It is shown that the intermediate conveying devices 400 applying the pulling force to the electric cable 100 can adapt to the diameter of the electric cable 100 lying between the upper and the lower part of the intermediate conveying device 400.

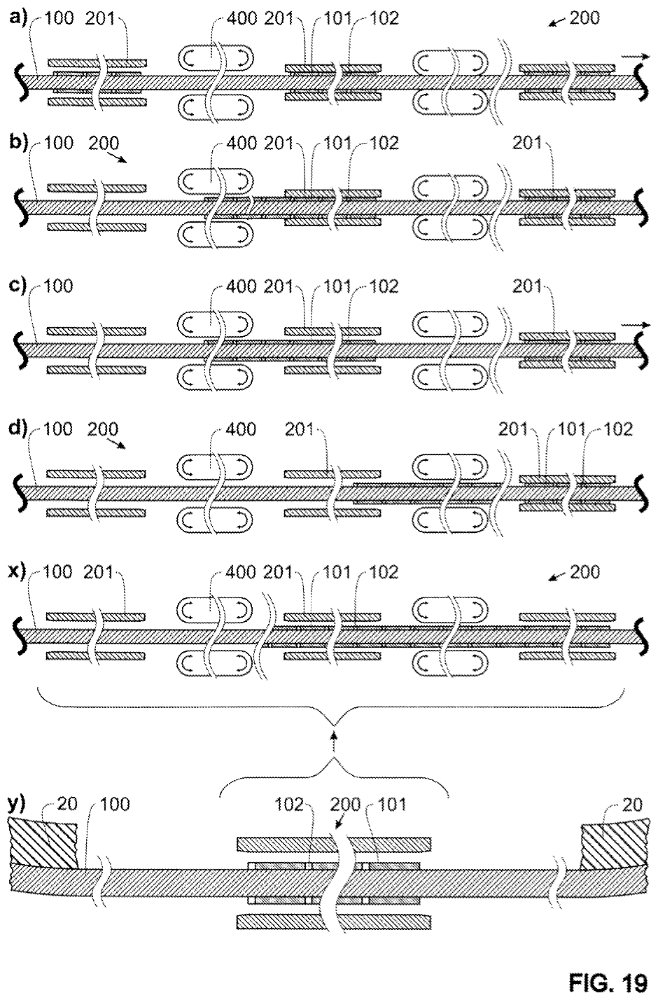

FIG. 19—Tubular Hull Application Process with Multiple Tubular Hull Application Units

In FIG. 19, the process steps for the simultaneous application of stiff tubes 101 and flexible rings 102 by means of multiple tubular hull application subunits 201 are shown.

The application of the process steps as shown in FIGS. 19a)-x) carried out with multiple tubular hull applications subunits 201 and intermediate conveying devices 400 has the same effect as the application of stiff tubes 101 and flexible rings 102 by means of the tubular hull application unit 200 having a single subunit, as shown in FIG. 19y), with the exception that the applied partial tubular hull 120 has a greater length when applying the process steps according to FIGS. 19a)-x). The process steps shown in FIGS. 18b) and 18d) together with the process steps shown in FIGS. 19a)-x) with the simultaneous use of multiple tubular hull application subunits 201, can thus be understood as a substitute for the process steps shown in FIGS. 18a), 18c) and 19y) in which a part of the tubular hull 120 is applied to the electric cable 100 by means of only the tubular hull application unit 200 having a single subunit.

The process steps shown in FIGS. 18b. 18d) and FIGS. 19a)-x) can be integrated into the process steps as shown in FIGS. 11-15, in order to speed up the process for the application of a tubular hull 120 to the electric cable 100 by means of using multiple tubular hull application subunits 201 instead of a single subunit only.

In a first step, a plurality of partial tubular hulls 120 is applied to the electric cable 100 by means of a corresponding plurality of tubular hull application subunits 201. The partial tubular hulls 120 are arranged distant from each other along the length of the electric cable 100. In the subsequent steps shown in FIGS. 19a)-x), the plurality of partial tubular hulls 120 is moved together, such that there are no more spaces between them.

In a first step as shown in FIG. 19a), the tubular hull application subunit 201 arranged on the left side in the view of the figure releases the respective partial tubular hull 120 such that it is freely movable with the electric cable 100. Also the intermediate conveying device 400 positioned next to the respective opened tubular hull application subunit 201 releases the electric cable 100, e.g. by means of linear actuators.

In FIG. 19b), it is shown, how the electric cable 100 is then pulled to the right side (in the view of the figure), in order to move the partial tubular hull 120 that has just been released. The electric cable 100 is pulled so far that the respective partial tubular hull 120 is placed directly adjacent to the neighbouring partial tubular hull 120 which is still fixed in the tubular hull application subunit 201 shown in the middle of the figure.

As shown in FIG. 19c), the tubular hull application subunit 201 arranged in the middle of the figure then releases the partial tubular hull 120. Also the intermediate conveying device 400 positioned next to the respective opened tubular hull application subunit 201 releases the electric cable 100.

As the next step, it is shown in FIG. 19d), that the electric cable 100 is pulled further to the right side (in the view of the figure), in order to move the partial tubular hull 120 that has just been released in the step illustrated in FIG. 19c) together with the electric cable 100. The electric cable 100 is pulled so far that the respective partial tubular hull 120 is placed directly adjacent to the next neighbouring partial tubular hull 120 which is still fixed in the next neighbouring tubular hull application subunit 201.

These process steps according to FIG. 19a)-d) can be repeated until all partial tubular hulls 120 are lined up in consecutive order and without spaces in-between, as it is shown in FIG. 19x).

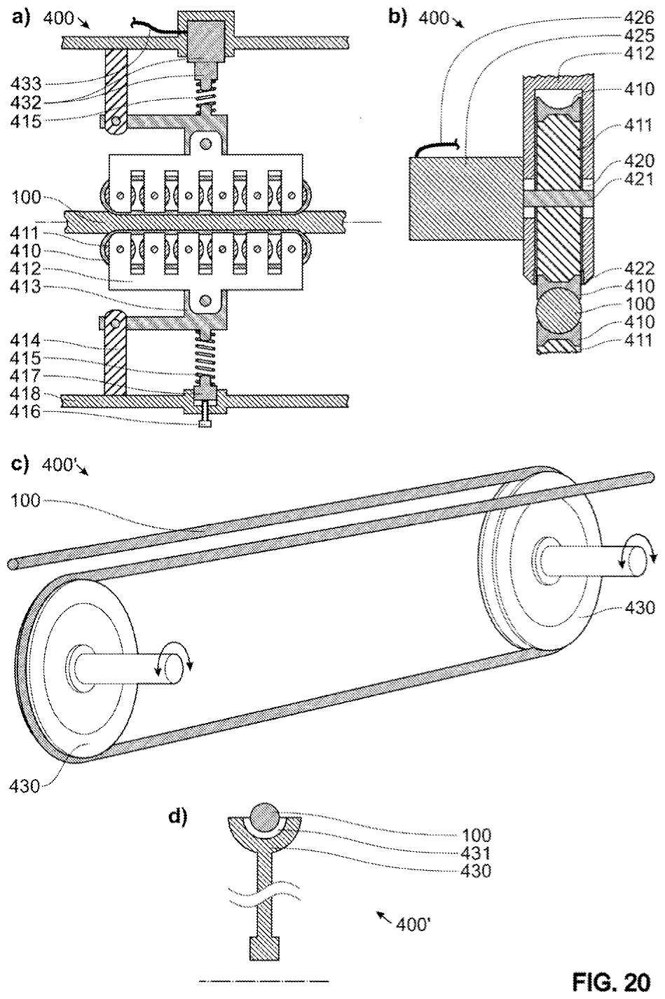

FIG. 20—Intermediate Conveying Device

FIG. 20 shows possible embodiments for the intermediate conveying devices 400 as described with respect to FIGS. 18 and 19.

FIG. 20a) shows an intermediate conveying device 400 with grip belts 410 for the linear traction of the electric cable 100 with or without the tubular hull 120. Two grip belts 410 are provided which bear from opposite sides against the electric cable 100 such that the electric cable 100 can be linearly conveyed by means of the friction and/or clamping force resulting from the grip belts 410.

The conveying device 400 as shown in FIG. 20a) comprises two sets of drive wheels 411 which are each attached to a first end of a yoke 412. Each set of drive wheels 411 serves to drive one of the two grip belts 410. The yokes 412 hold the drive wheels 411 and are each pivotably attached to a lever 413. The levers 413 enable the yokes 412 with the drive wheels 411 and the grip belts 410 attached thereon to be moved towards and away from the electric cable 100. For this purpose, a second end of each lever 413 is pivotably attached, via a lever joint 414, to a fame 418 of the conveying device 400.

In order to bias the grip belts 410 with a certain force against the electric cable 100, pressure springs 415 are provided which are arranged between the frame 418 and each of the levers 413. The force generated by the pressure spring 415 shown in the lower part of the figure can be adjusted by means of an adjustment screw 416. The adjustment screw 416 serves to cause a relative movement of an adjustment cylinder 417 with respect to the frame 418 towards and away from the yoke 412. Due to the attachment of the pressure spring 415 to the adjustment cylinder 417 the pressure exerted by the pressure spring 415 on the yoke 412 and, thus, on the grip belt 410 is influenced by a movement of the adjustment cylinder 417.

In order to release the electric cable 100 or to adapt to the significantly smaller diameter of the intermediate rod 401, at least the upper grip belt 410 as shown in FIG. 20a) can be actively moved away from and towards the electric cable 100. This active movement of the upper grip belt 410 is achieved by providing a linear actuator for moving a respective adjustment cylinder 432 with respect to the frame 418. Control data and power is supplied to the linear actuator by means of a power and data cable 433.

FIG. 20b) shows a central cross-sectional view through one of the drive wheels 411 attached to the upper yoke 412 of the intermediate conveying device as shown in FIG. 20a). As can be seen from FIG. 20b), the drive wheels 411 are attached to a wheel axle 421. At least some of the wheel axles 421 are drive axles, meaning that the respective drive wheels 411 can be driven, via the wheel axles 421, by means of a grip belt drive 425. Control data and power is supplied to the grip belt drive 425 by means of a power and data cable 426. Wheel bearings 420 might be provided for the attachment of the drive wheels 411 to the wheel axles 421.

As can also be seen in FIG. 20b), the pip belt 410 preferably has a concavely shaped outer surface, in order to increase the surface contacting the electric cable 100. Furthermore, the inner surface of the grip belt 410 can have local elevations and/or depressions, in order to engage in complementary formed local depressions and/or elevations of the drive wheels 411. Grip belt guiding elements 422 might be provided, in order to laterally guide the grip belt 410 in the regions of the drive wheels 411, where the grip belt 410 engages with the electric cable 100.

A further embodiment of an intermediate conveying device 400′ is shown in FIG. 20c). For conveying the electric cable 100, two or more sheaves 430 are provided. The electric cable 100, with or without a part of the tubular hull 120 attached thereto, is guided over and around each of the sheaves 430. By means of driving the sheaves 430, the electric cable 100 can be conveyed. In order to increase the contact surface between the sheaves 430 and the electric cable 100, the sheaves 430 preferably have a concavely-shaped radial outer surface, as shown in FIG. 20d). Between the electric cable 100 and the concavely-shaped radial outer surface, a flexible sheave buffer layer 431 can be provided.

REFERENCE NUMERALS

| | |
|---|---|
| 1, 1′ | Tubular hull application device |
| 2 | Linearly moveable drum unit |
| 3 | Rotary drum unit |
| 20 | Drum |
| 50 | Linearly moveable dram unit bearing |
| 51 | Linearly moveable drum unit bearing block |
| 52 | Linearly moveable drum unit bearing and drive block |
| 53 | Linearly moveable dram unit drive |
| 55 | Stationary drum unit base |
| 60 | Threaded rod |
| 61 | Slide |
| 63 | Mounting block |
| 64 | Drive |
| 65 | Power and data cable |
| 70 | Drive |
| 71 | Power and data cable |
| 72 | Support |
| 75 | Rotary table |
| 76 | Rotary table drive |
| 77 | Drive gear |
| 78 | Further power and data cable |
| 79 | Toothed ring |
| 80 | Base structure |
| 81 | Bearing outer ring |
| 82 | Cylinder bearing |
| 83 | Cylindrical part |
| 100 | Electric cable |
| 101 | Stiff tube |
| 102 | Flexible ring |
| 110 | Electric conductor unit |
| 111 | Protection layer |
| 115 | Buffer layer |
| 120 | Tubular hull |
| 141 | Fiber optic cable/cables |
| 142 | Elastic core |
| 143 | Electric conductors |
| 144 | First semi-conductive layer |
| 145 | Electric insulation |
| 146 | Second semi-conductive layer |
| 147 | Electric conductors |
| 160 | Tensile armour layer |
| 170 | Tether |
| 200, 200′ | Tubular hull application unit |
| 201 | Tubular hull application subunit |
| 210 | Pull-in rod |
| 211 | Pull-in rod end connection |
| 212 | Drum connection rope |
| 213 | Rope end connection |
| 214 | Connection element |
| 215 | Pulling head |
| 216 | Pulling head end connection |
| 240, 240′, 240″ | Tube and ring feeder unit |
| 241 | Tube feeder frame |
| 242 | Tube feeder wheel |
| 243 | Wheel axle |
| 244 | Toothed axle wheel |
| 245 | Tube feeder wheel drive |
| 246 | Toothed drive wheel |
| 247 | First toothed belt |
| 248 | Journal bearing |
| 249 | Second toothed belt |
| 250 | Intermediate axle |
| 251 | Tube feeder intermediate axle frame |
| 252 | Wheel axle support |
| 253 | First intermediate toothed wheel |
| 254 | Second intermediate toothed wheel |
| 255 | Tube feeder unit |
| 256 | Ring feeder unit |
| 261 | Ring feeder frame |
| 262 | Ring feeder wheel |
| 263 | Wheel axle |
| 264 | Toothed axle wheel |
| 265 | Ring feeder wheel drive |
| 266 | Toothed drive wheel |
| 267 | First toothed belt |
| 268 | Journal bearing |
| 269 | Second toothed belt |
| 270 | Intermediate axle |
| 271 | Ring feeder intermediate axle frame |
| 273 | First intermediate toothed wheel |
| 274 | Second intermediate toothed wheel |
| 275 | First vacuum connector |
| 276 | Second vacuum connector |
| 277 | Pressure control unit |
| 280 | Feeder unit opening drive |
| 281 | Opening spindle |
| 282 | Opening drive frame |
| 283 | Journal bearing |
| 285 | Base structure |
| 287 | Guide rod |
| 289 | Sealing elements |
| 290 | Case |
| 291 | Case |
| 292 | First vacuum connector |
| 293 | Second vacuum connector |
| 294 | Pressure control unit |
| 295 | Sealing elements |
| 296 | Sealing elements |
| 297 | Sealing elements |
| 298 | Seat sealing element |
| 299 | Seat sealing element |
| 300 | Moveable base plate |
| 302 | Stationary base plate |
| 303 | Dust protection plate |
| 304 | Dust sealing elements |
| 305 | Gliding plate |
| 310 | Linear actuator |
| 311 | Fixation bolt |
| 312 | Base fixation |
| 315 | Rolling ball bearing |
| 316 | Large rolling ball |
| 317 | Small rolling ball |
| 318 | Rolling ball bearing support |
| 319 | Annular sealing element |
| 325 | Channels |
| 326 | Medium connector |
| 350 | Compressed air insertion unit |
| 351 | Sealing element |
| 352 | Annular sealing element |
| 353 | Inlet gas connector |
| 354 | Main body |
| 355 | Centering element |
| 360 | Closing ring |
| 370 | Linear conveying device |
| 371 | Crawler band |
| 372 | Crawler wheel |
| 380 | Pulling head protection layer |
| 381 | Clamping fixation |
| 400, 400′ | Intermediate conveying device |
| 401 | Intermediate rod |
| 402 | Intermediate end connection |
| 410 | Grip belt |
| 411 | Drive wheel |
| 412 | Yoke |
| 413 | Lever |
| 414 | Lever joint |
| 415 | Pressure spring |
| 416 | Adjustment screw |
| 417 | Adjustment cylinder |
| 418 | Frame |
| 420 | Wheel bearing |
| 421 | Wheel axle |
| 422 | Grip belt guiding element |
| 425 | Grip belt drive |
| 426 | Power and data cable |
| 430 | Sheave |
| 431 | Sheave buffer layer |
| 432 | Adjustment cylinder |
| 433 | Power and data cable |

1. A method for the application of a tubular hull to an electric cable, the tubular hull comprising a plurality of ring-shaped elements and/or of tube-shaped elements, wherein the plurality of ring-shaped elements and/or of tube-shaped elements are arranged one behind the other along the longitudinal direction of the electric cable, and wherein the method comprises at least the following steps in consecutive order:
a.) pre-arranging a part of the tubular hull by means of a tubular hull application unit;
b.) applying the pre-arranged part of the tubular hull to the electric cable by means of inserting the electric cable into the tubular hull application unit and into the pre-arranged part of the tubular hull;
c.) removing the electric cable from the tubular hull application unit; and
x.) repeating steps a.), b.) and c.) at least two times and in consecutive order.

2. The method according to claim 1, wherein in step x.), steps a.), b.) and c.) are repeated until the tubular hull covers most of the overall longitudinal extension of the electric cable.

3. The method according to claim 1, wherein in step b.) and before step x.), the pre-arranged part of the tubular hull is applied approximately to the middle of the electric cable.

4. The method according to claim 1,
wherein in the first repetition of step b.) in step x.), the electric cable is inserted into the pre-arranged part of the tubular hull along a first longitudinal direction of the electric cable,
wherein in the second repetition of step b.) in step x.), the electric cable is inserted into the pre-arranged part of the tubular hull along a second longitudinal direction of the electric cable, and
wherein the second longitudinal direction of the electric cable extends oppositely to the first longitudinal direction of the electric cable.

5. The method according to claim 1, wherein in each repetition of step b.) in step x.), the pre-arranged part of the tubular hull is applied such to the electric cable, that the pre-arranged part of the tubular hull is placed directly adjacent to a part of the tubular hull that has already been applied to the electric cable in a previous step b.).

6. The method according to claim 1,
wherein the tubular hull has an inner diameter and the electric cable has an outer diameter, and
wherein the outer diameter of the electric cable is larger than the inner diameter of the tubular hull in a state before the application of the tubular hull to the electric cable.

7. The method according to claim 1,
wherein the tubular hull application unit comprises a plurality of tubular hull application subunits, and
wherein each part of the tubular hull that is pre-arranged in step a.) and applied to the electric cable in step b.) comprises a plurality of subparts which are applied to the electric cable distantly from each other by means of the tubular hull application subunit.

8. The method according to claim 7, wherein the subparts are first applied distantly from each other to the electric cable and are then moved towards each other, in order to be arranged directly adjacent to each other.

9. The method according to claim 1, wherein in step b.), the insertion of the electric cable into the pre-arranged part of the tubular hull is carried out in a spooling/unspooling process by means of drums.

10. The method according to claim 9, wherein at least one pull-in rod is used, in order to attach the electric cable to one of the drums.

11. The method according to claim 9,
wherein the drums are linearly moved during the spooling/unspooling process, in order to not deflect the electric cable in the region between the drums, and/or
wherein each of the drums has a spooling axis around which the drum rotates for the spooling/unspooling process and each of the drums is rotated during the spooling/unspooling process about an axis perpendicular to the spooling axis, in order to not deflect the electric cable in the region between the drums.

12. The method according to claim 1, wherein in step b.), the electric cable and/or a pull-in rod to which the electric cable is attached is inserted into the part of the tubular hull by means of air pressure.

13. The method according to claim 1, wherein, in step a.), one or several of the ring-shaped elements and/or one or several of the tube-shaped elements are pre-arranged by means of at least one rotating wheel having one or several seats for receiving one of the ring-shaped elements and/or one of the tube-shaped elements.

14. The method according to claim 12, wherein a plurality of rotating wheels are provided for the pre-arrangement of ring-shaped elements and/or of tube-shaped elements in step a.), and wherein this plurality of rotating wheels is driven by a common drive.

15. A tubular hull application device adapted to apply a tubular hull to an electric cable and comprising at least one tubular hull application unit for pre-arranging a part of the tubular hull as well as drums for moving the electric cable in and out of the pre-arranged part of the tubular hull, the tubular hull application device being adapted to:
a.) pre-arrange a part of the tubular hull by means of the tubular hull application unit;
b.) apply the pre-arranged part of the tubular hull to the electric cable by means of inserting the electric cable into the tubular hull application unit and into the pre-arranged part of the tubular hull;
c.) remove the electric cable from the tubular hull application unit; and
x.) repeat steps a.), b.) and c.) at least two times and in consecutive order.

16. The method according to claim 2, wherein in step x.), steps a.), b.) and c.) are repeated until the tubular hull covers essentially the entire overall longitudinal extension of the electric cable.

17. The method according to claim 4, wherein in each odd-numbered repetition of step b.) in step x.), the electric cable is inserted into the pre-arranged part of the tubular hull along the first longitudinal direction of the electric cable, wherein in each even-numbered repetition of step b.) in step x.), the electric cable is inserted into the pre-arranged part of the tubular hull along the second longitudinal direction of the electric cable.

18. The method according to claim 7, wherein one or several intermediate conveying devices are used for conveying the electric cable between the tubular hull application subunits.

19. The method according to claim 10, wherein at least one drum connection rope is used, in order to attach the pull-in rod to one of the drums.

20. The method according to claim 13, wherein, during the insertion of the electric cable in step b.), the ring-shaped element and/or the tube-shaped element is held in place on the rotating wheel by means of underpressure.
